(19) United States
(12) Patent Application Publication
(10) Pub. No.: US 2026/0141265 A1
(43) Pub. Date: May 21, 2026

(54) SELF-EVOLVING LANGUAGE MODELS WITH DYNAMIC MEMORY UPDATES AND REFLECTION-BASED ADAPTATION

(71) Applicant: Writer, Inc., San Francisco, CA (US)

(72) Inventor: Waseem AlShikh, Boca Raton, FL (US)

(73) Assignee: Writer, Inc., San Francisco, CA (US)

(21) Appl. No.: 19/347,598

(22) Filed: Oct. 1, 2025

Related U.S. Application Data
(60) Provisional application No. 63/722,539, filed on Nov. 19, 2024.

(51) Int. Cl. G06N 5/022; G06F 40/284

(52) U.S. Cl. CPC G06N 5/022; G06F 40/284

(57) ABSTRACT

The present disclosure relates to techniques for enabling dynamic memory evolution in large language models (LLMs) by selectively integrating user-provided facts or information during real-time interactive sessions. The disclosed techniques may include, upon receiving an input prompt from a user, generating a set of memory-weighted tokens using multiple transformer layers, each coupled to a dedicated memory pool comprising memory tokens that represent the model's internal knowledge. These memory-weighted tokens may be analyzed to identify salient, new, or distinct information in the input prompt relative to the existing memory content. The identified knowledge may then be incorporated into one or more memory pools prior to generating a response. The disclosed techniques may enable the LLM to autonomously adapt and refine its internal memory based on user-provided domain knowledge, personal preferences, or factual corrections, facilitating progressive enhancement of internal knowledge without reliance on manual retraining or calibration.

### CROSS-REFERENCE TO RELATED APPLICATIONS

This application claims the priority to, and the benefit of U.S. Provisional Application No. 63/722,539 filed on Nov. 19, 2024, entitled “Self-evolving Large Language Models (LLMs) and Systems and Uses Thereof”, which is hereby incorporated by reference in its entirety for all purposes.

### BACKGROUND

The rapid advancement of artificial intelligence (AI), particularly in the field of natural language processing (NLP), is leading the widespread adoption of large language models (LLMs) across a range of application domains. These models demonstrate notable proficiency in tasks such as text generation, summarization, translation, and open-ended question answering (i.e., in chatbot applications). However, the deployment of LLMs in real-world environments faces significant challenges due to the static nature of their learning and generalization capabilities (e.g., in non-thinking models). Most existing non-thinking LLMs are trained on fixed datasets and rely on static knowledge representations, limiting their ability to adapt to evolving user needs, domain-specific updates, or rapidly changing information landscapes. Moreover, the knowledge embedded within these models is typically bound by a cutoff date, beyond which the models lack awareness of new developments or events. Consequently, such models typically do not achieve desired operational performance especially in dynamic environments, with a continuously evolving context. Therefore, extensive retraining or manual intervention may be needed to adapt to such dynamic environments.

Conventional strategies to address these limitations have primarily focused on fine-tuning pre-trained models using domain-specific or task-specific datasets. While such methods can offer targeted improvements, they also introduce several operational and technical constraints. Fine-tuning typically involves significant overhead in terms of data collection, preprocessing, and annotation, in addition to the need for domain specific expert knowledge. Furthermore, fine-tuned models often exhibit narrow generalization and may degrade when applied to unforeseen use cases or out-of-distribution inputs. This rigidity may necessitate frequent retraining cycles to maintain performance, resulting in limited scalability in production-grade deployments and increased cost of maintenance.

### SUMMARY

Some aspects of the present disclosure relate to techniques for enabling dynamic, memory evolution in large language models (LLMs), referred to herein as a “self-evolving language model” (SELM), by selectively integrating user-provided facts or information during real-time interactive sessions. The disclosed techniques may include receiving, via a user interface (UI), an input prompt from a user in a natural language format. The UI may be a user-facing application such as a virtual AI assistant, a customer service chatbot, or a research assistant embedded within a productivity tool suite. Additionally, the input prompt may correspond to a prompt or a query in an interaction session and may further include a correction or a factual contradiction to a previously generated response, a personal preference, or an informational query.

According to the disclosed techniques, a query, that is originally expressed in a natural language format, may first be tokenized into a set of input tokens and subsequently transformed into corresponding embeddings (referred to herein as input embeddings), using one or more decoder layers of the SELM. The embedding may be a high-dimensional numerical representation (i.e., a dense vector) that may encode semantic meaning and contextual nuances of the input prompt. This transformation may be performed using pretrained neural network-based language models such as BERT, RoBERTa, or sentence-transformer variants (e.g., SBERT, MiniLM, etc.), which may convert a raw textual input prompt into semantically meaningful embeddings. Therefore, the SELM (also referred to herein as model) may generate the set of input tokens and input embeddings corresponding to the input prompt and can subsequently use them in downstream language processing pipelines.

The input embeddings may serve as a primary input in attention computation mechanism within subsequent transformer layers of the SELM. According to the disclosed techniques, a contextualized embedding may be generated corresponding to each input token of the set of tokens. The SELM may comprise a plurality of transformer layers, each of which may be coupled to a dedicated, localized memory pool configured to operate at a layer-specific semantic granularity. The plurality of memory pools, each associated with a corresponding transformer layer, may collectively be referred to herein as “internal memory” of the SELM. Each memory pool may store a plurality of memory tokens in the form of high-dimensional embeddings, wherein each dimension of the embedding corresponds to a distinct semantic, temporal, or contextual feature of an underlying concept or topic. Furthermore, each memory token may be associated with an uncertainty embedding, wherein each dimension of the uncertainty embedding may correspond to an uncertainty score for a respective dimension of the memory token embedding. Consequently, the uncertainty embedding may provide fine-grained confidence values across all the semantic dimensions of the embedding corresponding to the memory tokens, in contrast to conventional scalar uncertainty measures.

The uncertainty score in this context may represent a degree of confidence or reliability, assigned to a memory token, at the time of its inclusion in a memory pool, reflecting its factual consistency, contextual clarity, and semantic stability based on one or more internal evaluation metrics. In contrast with conventional memory-augmented language models and external retrieval-based models, which typically rely on a global memory store or external databases, the disclosed SELM enables transformer layers to evolve their own localized memory representations, enriched by dimension-wise uncertainty tracking, thereby enabling self-contained, fine-grained, and dynamically adaptive memory management.

During the generation of contextualized embeddings, each transformer layer may be configured to separately apply attention mechanism on the set of input tokens by leveraging the associated memory pool. The attention mechanism may include applying self-attention on the input tokens, followed by applying cross-attention using the memory tokens. Therefore, the final contextualized embeddings may comprise a set of memory tokens derived from each transformer layer, found to be contextually relevant to the input tokens. Additionally, the contextualized embeddings may comprise attention weights corresponding to each memory token of the set of memory tokens, assigned based on a degree of similarity with the input tokens. The disclosed techniques may involve filtering, based on the assigned attention weights and the corresponding uncertainty scores of the set of memory tokens, a subset of input tokens may exhibit a degree of dissimilarity or information divergence relative to the set of memory tokens.

In some aspects, the filtration process may further comprise identifying one or more input tokens of the set of input tokens for which a predefined number of memory tokens, that are contextually relevant, exhibit low values for both the uncertainty scores and the associated attention weights, relative to a predefined threshold value. As a result, the identified one or more input tokens may represent information that may not have been present in the model's internal memory. Similarly, one or more input tokens of the set of input tokens for which a predefined number of contextually relevant memory tokens may be identified that may exhibit high values for both the uncertainty scores and the associated attention weights, relative to the predefined threshold value. The identified one or more input tokens may represent a potential contradiction to or update of a previously known fact. Therefore, the one or more input tokens identified in this manner may further be downsized, or selectively filtered, to generate an exclusive subset of input tokens that may explicitly correspond to the most dissimilar, unique, or salient information conveyed by the user in the input prompt.

Subsequently, one or more memory pools of the plurality of memory pools may be selectively updated based on the derived subset of input tokens. As each transformer layer of the plurality of transformer layers may be responsible for capturing a distinct linguistic or semantic feature during the attention mechanism, such as lexical definitions at earlier layers and generic relationships at deeper layers, the memory pools tied to those layers may store disjoint or functionally distinct memory tokens. During the updating process, each input token of the derived subset may be assigned one or more uncertainty scores on a dimension-wise basis, wherein each uncertainty score corresponds to a respective dimension of the token's embedding. The dimension-wise uncertainty scores may be computed using one or more heuristics or techniques, including entropy-based measures, distributional divergence metrics, attention-weight stability, or temporal consistency across interaction turns.

Consequently, only the one or more memory pools may be updated based on the nature of the salient information identified in the user input and its relevance to the function of a particular transformer layer. Furthermore, the updating may yield oscillating uncertainty scores over time. The oscillations in the uncertainty scores may occur due to updates applied in response to successive input prompts, wherein such oscillations may reinforce frequently accessed memory tokens and decay less-relevant memory tokens across a plurality of interaction turns or sessions with a plurality of users. Finally, based on the updating of the one or more memory pools, the language model may proceed to generate a natural language response using one or more decoder layers, and the resulting response may be presented to the user via a user interface (UI).

According to the disclosed techniques, from each memory pool of the plurality of memory pools, a subset of memory tokens that may correspond to uncertain, outdated, or unreliable information elements stored in the internal memory of the language model. Such information elements may be periodically removed after each iteration of a memory update, or, in some aspects, after a predefined time interval. The disclosed techniques may involve filtering, from each memory pool, a subset of tokens that may have higher uncertainty scores relative to other memory tokens in the memory pool. Since the uncertainty scores corresponding to the set of memory tokens may be gradually oscillating across time (in response to successive input prompts across a plurality of interaction sessions with a plurality of users, reflecting the reinforcement of frequently accessed dimensions and decay of less-relevant dimensions), the filtration process may enable an iterative pruning of one or more dimensions of memory tokens that exhibit persistently elevated uncertainty scores. As a result, only high-confidence and contextually relevant information may be preserved within each memory pool of the plurality of memory pools across interaction turns.

The filtration process may be performed by leveraging one or more machine-learning (ML) models. The one or more ML models may include logistic regression, support vector machine (SVM), random forests, gradient boosting machines, or deep neural networks including recurrent neural networks (RNN), convolution neural networks (CNN), or transformer-based classifiers. In some aspects, rule-based heuristics or similarity metrics, such as cosine similarity or Euclidean distance, may be employed to augment the ML models. Moreover, the filtration process may incorporate thresholding strategies or techniques including SoftMax thresholding, top-k thresholding, percentile-based filtering, entropy-based ranking, or adaptive thresholds derived from distributional statistics of the attention weights or the uncertainty scores. The filtered subset of memory tokens may then be removed from their associated memory pools. The disclosed techniques may, therefore, enable maintaining high-quality tokens in the internal memory by eliminating unreliable or outdated data while simultaneously optimizing memory space to accommodate potential candidate tokens for future integration.

The disclosed techniques may further include receiving via a UI, another input prompt from the user in a natural language format. Upon receiving the other input prompt, another set of input tokens and another contextualized embedding, corresponding to the other input prompt, may be generated using the plurality of transformer layers of the large language model. Subsequently, the disclosed techniques may involve detecting a knowledge gap, based on the attention weights, assigned to the contextually relevant memory tokens corresponding to the contextualized embedding, and the associated uncertainty scores of the memory tokens.

sThe knowledge gap, in the present disclosure, may indicate that the large language model may lack sufficient internal information to respond to the other input prompt. Moreover, the detection may include determining, based on the attention weights assigned to a set of other memory tokens and their associated uncertainty scores, a predefined number (i.e., a majority) of memory tokens exhibit attention weights below a predefined threshold, while their corresponding uncertainty scores exceed a separate predefined threshold. Such a scenario may indicate that the other set of input tokens lack relevant or contextually aligned information in the internal memory; as a result, the memory tokens that are somewhat relevant may be considered as unreliable or semantically inconsistent with the contextual meaning of the input prompt.

Upon identifying such a knowledge gap, a function call may be triggered to activate an external research agent, which may be configured to retrieve contextually relevant and up-to-date information, referred to herein as one or more data items, pertaining to the other input prompt. The retrieved one or more data items may then be processed, using one or more natural language processing (NLP) techniques, to convert them into a structured representation that may align with a format of the internal memory. Additionally, the one or more NLP techniques may involve applying named entity recognition (NER), dependency parsing, sentence segmentation, relation extraction, or topic modeling to generate structured outputs that may include both a vector embedding representation and a tokenized textual representation. The structured data may then be stored into another one or more memory pools of the plurality of memory pools. Subsequently, another natural language response may be generated based on the updated internal memory and delivered to the user via the user interface (UI). In some aspects, the input prompt and the other input prompt may be the same.

According to the disclosed techniques, the self-evolving language model (SELM) may be configured to autonomously evolve and update its internal memory by periodically performing a self-reflection analysis. The self-reflection analysis may enable the SELM to identify one or more insights, including, for example, user-specific preferences, changes in domain knowledge, updates to the existing facts, or dynamic patterns in user behavior that may have been overlooked during the real-time memory update process. Moreover, the one or more insights may correspond to information that may be inferred by analyzing a progression of dialogue between the user and the large language model, rather than being derived from a single user input only. In some instances, an insight may capture a higher-level semantic or behavioral trend that may emerge across an entire interaction session, and may further contribute to iterative refinement of the SELM's internal memory.

The disclosed techniques may include accessing, from one or more data sources associated with the SELM, interaction data corresponding to a plurality of past interaction sessions involving a plurality of users. Each interaction session may include one or more user input prompts and the corresponding one or more responses generated by the SELM. For each of these interaction sessions, associated with a given user, the disclosed techniques may involve applying another one or more NLP techniques to analyze the interaction data and identify one or more insights. The identified insights may include: (1) user-specific preferences expressed in a dialogue; (2) one or more user-provided corrections or contradictions to a prior model response, along with the corrected or clarified information in one or more follow-up input prompts; and (3) domain-specific factual knowledge that may be introduced by the user using the one or more input prompts. Subsequently, the identified insights may be converted into one or more structured representations by applying additional NLP techniques. Thereafter, one or more memory pools of the SELM may be updated to include the structured representations of the insights, allowing the model to refine its internal knowledge based on accumulated user interactions.

In some embodiments, a system is provided that includes one or more data processors and a non-transitory computer readable storage medium containing instruction which, when executed on the one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 illustrates an overview of a self-evolving language model (SELM) configured to process an input prompt from a user and generate a response in accordance with some aspects of the present disclosure.

FIG. 2 shows an exemplary block diagram of a prompt processing unit and a plurality of transformer layers for generating a set of memory-weighted tokens corresponding to the input prompt, in accordance with some aspects of the present disclosure.

FIG. 3 illustrates an exemplary block diagram of a memory manager for updating one or more memory pools associated with one or more transformer layers, in accordance with some aspects of the present disclosure.

FIG. 4 shows a block diagram of a self-reflection module for detecting one or more insights from a user interaction in accordance with some aspects of the present disclosure.

FIG. 5 shows an example flowchart of a model for validating one or more insights and performing a corresponding action in accordance with some aspects of the present disclosure.

FIG. 6 shows a block diagram of a self-guided research module (SGRM) for detecting a knowledge gap based on a user prompt and retrieving external content for updating the one or more memory pools accordingly.

FIG. 7A illustrates an exemplary user interface (UI), displaying a sequence of dialogue exchanges between a user and an interactive artificial intelligence (AI) assistant, in accordance with some aspects of the present disclosure.

FIG. 7B illustrates an exemplary user interface (UI) displaying the interactive AI assistant responding to a research-oriented prompt from a user in accordance with some aspects of the present disclosure.

FIG. 8A illustrates a graph depicting performance statistics of the SELM across multiple iterations of evaluation, in accordance with some aspects of the present disclosure.

FIG. 8B shows a graph depicting progressive performance statistics of the SELM in terms of harmful refusal rates across multiple iterations of evaluation.

FIG. 9 shows an example flowchart of a model for processing an input prompt from a user and generating a response in accordance with some aspects of the present disclosure.

### DETAILED DESCRIPTION

Some aspects of the present disclosure relate to techniques for enabling dynamic, memory evolution in large language models (LLMs) by selectively integrating user-provided facts or information during real-time interactive sessions. The internal memory, in the present disclosure, may refer to a plurality of memory pools (also referred to herein as memory pools), each of which may be associated with a respective transformer layer of a plurality of transformer layers implemented within the LLM. Additionally, each memory pool may store a set of memory tokens, with each memory token stored with an associated uncertainty score. The uncertainty score in this context may represent a degree of confidence or reliability assigned to a memory token at the time of its inclusion in a memory pool, reflecting its factual consistency, contextual clarity, and semantic stability based on one or more internal evaluation metrics. The uncertainty scores, according to the disclosed techniques, may guide both the update process of the memory pools in response to the input prompt and a downstream processing of the input prompt during the generation of the response.

In contrast to architectures that augment language models with external retrieval modules (i.e., RAG pipelines or memory augmented systems), the disclosed SELM establishes an intrinsic and layer-localized memory paradigm. This tight coupling of layered memory with uncertainty-aware token management may enable the SELM to selectively reinforce stable knowledge while adaptively refining volatile or time-sensitive content. Consequently, the disclosed techniques may elevate memory evolution from an auxiliary retrieval process to a core inference-time capability, allowing the SELM to sustain continuity, adaptability, and semantic fidelity throughout interactive sessions.

According to some aspects, the LLM, also referred to herein as a “self-evolving language model” (SELM), may refer to a neural network-based language model architecture that may be implemented using transformer-based components and configured to include an internal memory subsystem for processing and responding to user input prompts. In some aspects, the SELM may embody foundational models, such as domain-specific transformer stacks or lightweight encoder-decoder networks that may further be enhanced by a dedicated internal memory in the form of memory pools. Since each memory pool of the plurality of memory pools may be operatively associated with a respective transformer layer; therefore, this may enable the SELM to dynamically store, retrieve, and update the memory tokens across varying levels of semantic representation without relying on external retrieval-augmented generation (RAG) techniques. In contrast to language models that may depend on external databases or knowledge sources, the SELM may utilize its own internal memory to facilitate contextual grounding, iterative learning, and adaptive response generation directly from within the model's execution environment. The terms “large language model,” “language model,” “model,” and “self-evolving language model (SELM),” may be used interchangeably throughout the present disclosure.

According to some aspects, the transformer-based architecture of the SELM, comprising a plurality of transformer layers, may be configured to operate at a distinct representational level for processing the input prompts. For instance, lower transformer layers may be configured to capture lexical and syntactic patterns between multiple tokens, corresponding to the input prompt, enabling the model to understand sentence structure and local dependencies. Intermediate transformer layers may learn compositional semantics and infer logical or referential relationships between the tokens, while higher transformer layers may encode discourse-level context, long-range dependencies, and user-specific intent, enabling coherent dialogue understanding. The use of multiple transformer layers in this hierarchical manner may offer several technical advantages over single-layer architectures; for instance, enabling the SELM to incrementally refine contextual representation or embeddings corresponding to the input prompt. These embeddings may be enriched at each transformer layer by incorporating progressively deeper semantic relationships and structural patterns based on the memory tokens. Such multi-level contextualization may enhance the ability of the SELM to accurately identify and extract salient, distinct, or latest information from the input prompt for inclusion in the memory pools. Moreover, the enriched embeddings may facilitate in a more effective and informed selection and weighting of relevant memory tokens during response generation, that in turn, may enhance the coherence, relevance, and factual consistency of the generated response.

In some aspects, the SELM may serve as a backend engine within a generative AI (GenAI) platform, supporting interactive agents, AI assistants, or applications such as chatbots, virtual assistants, recommendation systems, document summarizing scribes, or code generation agents. The GenAI platform may comprise various subsystems, including a user interface (UI) for input/output interaction, an orchestration layer for managing API calls, and the SELM responsible for processing the input prompt and then generating appropriate and relevant responses in dynamic environments with a continuously evolving context.

A user, in this context, may be an individual interacting with the AI assistant through a UI (i.e., a web browser, mobile app, or embedded widget) capable of submitting a query, a prompt, or a question. The prompt from the user, also referred to herein as the input prompt, may be a natural language prompt including conversational inputs, contextual questions, or issue-specific prompts aimed at eliciting a substantive, insight-enriched response. In some aspects, the input prompt may reflect a broader conversational flow, involving multiple exchanges, such as a correction to a prior response or an output generated by the AI assistant, a shift in a stylistic preference, or a prompt seeking insights on unfolding latest trends.

Upon receiving such a prompt, it may be routed to the SELM via a communication network or a cloud network. The network may comprise a combination of private or public data channels (e.g., the Internet, enterprise intranets, or secure cloud APIs) that may facilitate connectivity between the user interface (UI) and the backend GenAI infrastructure hosting the SELM. Once the input prompt is received, the SELM may initiate a multi-stage pipeline that may include tokenization, embedding generation, a potential update of one or more memory pools, and finally, response generation.

The disclosed techniques may involve tokenizing the received input prompt into a set of input tokens and generating embeddings corresponding to each input token of the set of input tokens. The resulting set of input tokens, with their corresponding input embeddings, may subsequently be forwarded to the plurality of transformer layers (also referred to herein as “transformer layers”) for further processing. The terms “input tokens” and “set of input tokens” may be used interchangeably throughout the present disclosure.

According to the disclosed techniques, each transformer layer may be configured to apply an attention mechanism independently to the input tokens, using its dedicated memory pool. The attention mechanism may refer to computing a contextual similarity between each input token of the set of input tokens and the memory tokens stored in the dedicated memory pool. At each transformer layer, the application of the attention mechanism may enable an identification of memory tokens that are contextually relevant to input tokens. The identified memory tokens may then be assigned corresponding attention weights (also referred to herein as attention scores) based on a degree of contextual similarity or relevance, resulting in the generation of a contextualized embedding that may correspond to a set of memory-weighted tokens corresponding to the input tokens. The memory-weighted tokens may, therefore, comprise input tokens that have been dynamically enriched with semantically relevant memory content (i.e., the memory tokens), along with the assigned attention scores. As a result, the enriched, memory-weighted tokens may enable the SELM to perform a more grounded and accurate evaluation of the input prompt with respect to its existing internal memory. This comparative evaluation may facilitate the detection of one or more fragments of the input prompt that may not have been previously observed or encountered by the SELM. Based on the detection, the SELM may trigger the memory update process to selectively incorporate the newly identified content into its internal memory for long-term utility.

In some aspects, the memory-weighted tokens may be evaluated based on the uncertainty scores of the semantically relevant memory tokens to identify, from the set of input tokens, a subset of input tokens that may represent an informational divergence, distinctness, or dissimilarity relative to the semantically relevant memory tokens. The identified subset of input tokens may be flagged as candidate memory tokens to be included or replaced in one or more memory pools corresponding to one or more transformer layers, as they may potentially indicate new preferences, corrections or contradiction to known facts, or emerging insights that may not have been previously stored in the internal memory. The evaluation of the memory-weighted tokens may be based on one or more predefined heuristic conditions.

A heuristic condition may include, for example, a rule specifying that if an input token receives relatively low attention from the memory tokens (i.e., only a small subset of memory tokens are identified as contextually relevant to the input token), and even if the associated uncertainty scores of those memory tokens are relatively low (indicating that they may likely be reliable or trusted memory tokens), the input token may be inferred as a new or unfamiliar fact that may be previously unseen by the model. This condition may signal the absence of semantically similar content in the internal memory, prompting the SELM to store one or more input tokens in the internal memory. Another heuristic condition may involve a situation when an input token may be associated with one or more high attention weights memory tokens based on their contextual relevance, but still a majority of those memory tokens may have high uncertainty scores, implying the input token contradicts or challenges unreliable or less trustworthy knowledge sources that may be currently stored in the memory pools. Accordingly, in both conditions, the SELM may flag the input token as a candidate memory token for its inclusion in the internal memory (i.e., the one or more memory pools).

According to the disclosed techniques, the SELM may assign uncertainty scores to each token of the one or more candidate memory tokens based on learned heuristics or using one or more machine-learning (ML) models prior to its inclusion in the one or more memory pools. Additionally, the disclosed techniques may include periodically or iteratively identifying, after a predefined time interval or following each memory update instance, a subset of memory tokens, from each memory pool associated with each transformer layer that may exhibit relatively high uncertainty scores compared to other memory tokens. As disclosed herein, a high uncertainty score may indicate low confidence or reliability of a corresponding memory token in the current context of answering one or more input prompts. The identification of a plurality of memory tokens, referred to herein as “stale memory tokens,” may include implementing one or more thresholding techniques configured to isolate memory tokens whose uncertainty scores fall below a predefined threshold of uncertainty. The one or more thresholding techniques may include a top K selection, fixed-score cutoff technique, or percentile-based thresholding. Accordingly, the identified stale memory tokens may periodically be removed or dropped from their respective memory pools, which may prevent retention or propagation of inaccurate, outdated, or noisy information in the long-term internal memory. In this manner, the disclosed techniques may enable the SELM to autonomously calibrate and update its internal memory by iteratively removing unreliable memory content, and simultaneously integrating new candidate memory tokens, derived from real-time user input prompts, into the memory pools.

Based on the updated memory pools, the SELM may initiate the response generation process by reprocessing the input tokens corresponding to the input prompt. The disclosed techniques may involve leveraging a self-attention and a cross-attention mechanism, implemented via the transformer layers, to generate another contextualized embedding based on the updated memory pools. The attention weights corresponding to each memory token, which may be computed during the generation of the other contextualized embeddings, may now be modulated or influenced by the respective uncertainty scores of the memory tokens. The contextualized embeddings may subsequently be forwarded to one or more decoder layers of the SELM, which may be configured to generate a response to the user in a natural language format. Therefore, unlike retrieval-augmented generation (RAG) systems or memory-augmented approaches that rely on external data sources, the disclosed SELM employs internal memory pools directly integrated within each transformer layer, enabling intrinsic information retrieval and contextual grounding across multiple representational levels during inference, without dependence on external stores. Furthermore, memory tokens enriched with vectorized uncertainty scores may enable selective pruning and replacement of stale, outdated information, preserving high-certainty knowledge while adaptively refreshing uncertain or obsolete information. As a result, the SELM transcends existing architectures by performing uncertainty-guided evolution of its internal memory during inference, yielding a dynamically adaptive model that may maintain contextual integrity without reliance on external retrieval mechanisms.

Some technical problems in existing, conventional language models may include the inability to autonomously incorporate new or evolving information after deployment. Such models may rely on static training datasets, resulting in a fixed internal memory that may be bound by a knowledge cut-off date—the latest time point to which the training data may have been included in training the language model. This constraint may prevent the model from accessing or reasoning over information encountered after deployment, limiting its responsiveness to new facts or user-specific contexts. As a result, conventional models may generate outdated, misaligned, or hallucinated responses, and may fail to personalize outputs effectively. Additionally, integrating new knowledge sources into these models may need costly retraining or fine-tuning operations that may not be feasible in real-time on large-scale deployed systems.

The disclosed techniques may solve the limitations of the models by enabling the SELM to autonomously update and evolve its internal memory without requiring manual retraining, fine-tuning, or external calibration. The SELM may dynamically integrate salient information, derived from real-time input prompts into its internal memory, including user-specific or up-to-date content that may not have been available during its initial training. The continuous memory update process may allow the SELM to overcome knowledge cut-off constraints, adapt to user-specific interactions, and refine its internal understanding over time. As a result, the SELM may provide relatively better responses, improve factual consistency and accuracy, and result in more personalized outputs across interactive sessions.

The techniques disclosed herein may facilitate the SELM to perform self-guided research based on real-time input prompts. The self-guided research process may involve determining, in real-time, upon the receipt of the input prompt from the user, whether an acceptable and semantically relevant information content is available in the internal memory to respond to the input prompt efficiently, effectively, and accurately. The input prompt, in this context, may be a research-oriented query. The determination may include evaluating the memory-weighted tokens, generated by the transformer layers based on another one or more predefined heuristic conditions. The other one or more heuristic conditions may include, for example, checking if a majority of input tokens of the set of input tokens are associated or contextualized with a fewer than a predefined threshold number of contextually relevant memory tokens during the attention mechanism. If the answer is affirmative, then this may indicate that it may not be possible to response to the prompt by using the number tokens available in the internal memory. Moreover, it might also be possible that a plurality of memory pools may lack contextually relevant information corresponding to the input tokens. Similarly, if the attention weights assigned between the input tokens and the retrieved, contextually relevant memory tokens fall below a predefined threshold, and a majority of the retrieved memory tokens exhibit relatively high uncertainty scores, it may be inferred that the internal memory lacks reliable or up-to-date information. Therefore, the occurrence of one or both conditions may indicate the presence of a knowledge gap.

In such instances, data content relevant to the input prompt may be retrieved from one or more external data sources by an external search agent and converted into corresponding tokens and embedding representations via one or more natural language processing (NLP) techniques. The generated tokens and corresponding embeddings may then be flagged as candidate memory tokens and stored into the one or more memory pools, prior to the response generation phase of the model. Each of these candidate memory tokens may also be assigned appropriate uncertainty scores based on one or more factors: (1) a credibility or reliability of the data source from which the content may have been retrieved, (2) an authorization status of the data source (e.g., whether the data content is a peer-reviewed or authorized publication or it may have been generated by an unauthorized or unverified user), or (3) a temporal recency (e.g., whether the content is recent or old). Accordingly, the appropriate uncertainty scores may be assigned to the candidate memory tokens, using one or more machine-learning (ML) models, based on the one or more factors.

The updated internal memory may then be used by the one or more decoder layers of the SELM for generating a natural language response, which may be reliable, contextually relevant, and based on up-to-date information. Therefore, the disclosed techniques may improve contextual adaptability, long-term consistency, efficiency, effectiveness, and responsiveness of the language model while reducing the need for external retraining, and dependency on external data retrieval systems. Furthermore, maintaining memory tokens with associated uncertainty scores in the memory pools may offer several technical advantages. For example, the memory update process, guided by the uncertainty scores, may allow prioritized retention or removal of memory tokens based on their perceived reliability, relevance, or confidence, maintaining a concise, up-to-date, and credible internal memory representation. As a result, this may reduce the risk of generating responses based on incorrect, outdated, or noisy information. Moreover, the uncertainty scores may modulate attention during the process of response generation, enabling the SELM to assign higher attention to the memory tokens with lower uncertainty values (i.e., higher confidence). Resultantly, improvements in the factual accuracy and coherence of the generated responses are increased along with hallucinated or speculative responses.

In some aspects, the disclosed techniques may facilitate the SELM in performing autonomous self-reflection analysis to continuously adapt its internal memory based on semantic, factual, or behavioral patterns observed across multiple user interactions. The SELM may be configured to revisit prior dialogues and analyze sequences of user input prompts and corresponding model's responses to identify latest insights. These insights may pertain to global preferences, emerging trends, or evolving social norms. For example, a recurring increase in the frequency of prompts that may be referring to the sustainability in business practices, ethical sourcing, or inclusive communication may indicate a broader societal interest in these topics. Additionally, insights may reflect a user-specific preferences, such as a consistent and continuous interest in legal developments, sports, and world politics, personalized content choices that may be determined from one or more interactions with an individual user. These insights may be flagged as candidate memory tokens and subsequently stored in the internal memory, enabling the generation of progressively adaptive and contextually tailored responses.

Unlike real-time memory updates that may involve evaluating a single input prompt against available memory tokens, the self-reflection analysis, on the other hand, may include detecting patterns of topics from extended, multi-turn conversations. Using one or more NLP techniques, the SELM may infer that certain information is missing or outdated based on user clarifications, model follow-up questions, or inconsistencies in its own responses. For instance, the user may state, “The government subsidy program for electric vehicles is discontinued this fiscal year,” or “This medication has been recently reclassified by the FDA due to newly discovered side effects,” prompting the SELM to identify knowledge gaps. Subsequently, the identified knowledge gaps can be addressed by validating and assigning uncertainty scores, using heuristic or learned models, and selectively integrated them into the internal memory to guide generation of responses in future conversations or interactions.

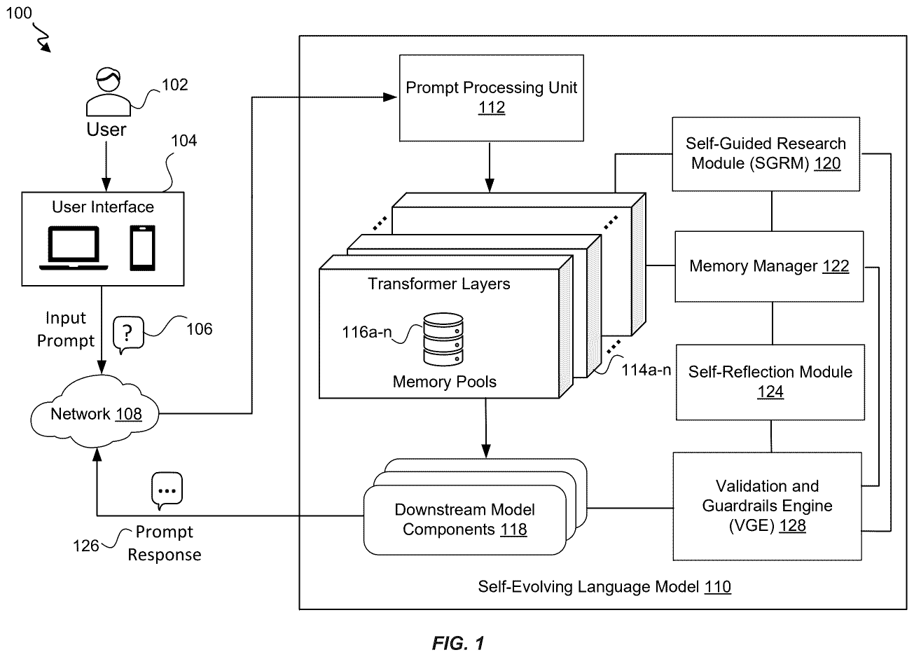

FIG. 1 illustrates an overview of a self-evolving language model (SELM) configured to process a user's query and generate a response, in accordance with some aspects of the present disclosure. Exemplary system 100 may include a user interface 104, a network 108, and a self-evolving language model (SELM) 110 that may be hosted by a GenAI cloud platform. The SELM 110 may comprise a prompt processing unit 112, one or more transformer layers 114a-n, one or more downstream model components 118, a self-guided research module (SGRM) 120, a memory manager 122, a self-reflection module 124, and a validation and guardrails engine (VGE) 128. Additionally, each layer of the one or more transformer layers 114a-n (also referred to herein as transformer layers 114a-n) may include a dedicated memory pool (collectively referred to herein as “memory pools 116a-n”).

The SELM 110 may be configured to autonomously evolve over time by continuously updating its internal storage (i.e., the memory pools 116a-n) in real-time based on the received input prompts 106 and/or web-based research, without the need for manual retraining or human intervention. Such updates may be triggered when the SELM 110 may detect contradictory information, novel insights, or factual gaps in its internal memory, allowing the model to dynamically refine its understanding of the knowledge sources. Moreover, the SELM 110 may identify newly provided facts within an input prompt 106 from the user 102 and reflectively incorporate those into relevant memory pools (a-n) 116 in real-time before generating an appropriate prompt response 126. Therefore, the SELM 110 may autonomously refine the memory contents, using context augmentation of interactions and without utilizing external retrieval-augmented generation (RAG) mechanisms. Consequently, it may reduce operational overhead, mitigate dependency on indexed document stores, and overcome the limitations of model training cut-off dates. As a result, the SELM 110 may generate timely, personalized, and up-to-date responses that may be aligned with user preferences and recent developments in domain-specific knowledge.

Additionally, in contrast to conventional LLMs that generate responses solely based on pretraining data or have to rely on RAG techniques, the SELM 110 may incrementally and selectively enhance its own memory tokens, stored across the memory pools 116a-n associated with the transformer layers 114a-n, enabling the model to cater for emerging prompts in the future. This may allow the SELM 110 to retain facts and preferences provided over time, such as a user 102 indicating “I prefer clinical examples instead of financial ones,” enabling the SELM 110 to tailor future responses according to the need and preferences of users. This self-updating or self-evolving capability may mitigate hallucinations, improve response relevance, and reduce the need for repeated prompt engineering or external context injection.

According to the disclosed techniques, the user interface 104 may be an application, a web-based interface, or a cloud-native app that may be accessible through user devices such as smartphones, tablets, or computers. The user interface 104 may allow a user 102 to submit natural language prompts (referred to herein as the input prompts 106) or queries to the application that may be an artificial intelligence (AI) virtual assistant, an interactive chatbot accessible through the GenAI cloud platform. The AI assistant may include conversational agents such as ChatGPT, GitHub Copilot, Google Gemini, Meta LLaMA or other chatbots powered by large language models (LLMs). These interfaces may be employed to process natural language inputs, generate contextually relevant responses, assist in task completion, provide intelligent code generation suggestions, summarize documents, or retrieve relevant information based on user queries. According to the disclosed techniques, the SELM 110 may be deployed as the backend inference engine of the abovementioned AI assistants, enhancing capabilities of traditional LLMs by implementing real-time context driven adaptation, memory updates or correction, and personalized learning.

Additionally, the self-evolving language model 110 in the disclosed techniques may be large-scale foundation models, such as large-language models (LLMs), and may also be lightweight or domain-specific small language models that are optimized for computational constraints in various operational environments (e.g., running queries locally on edge devices—smart phones, laptops etc.—to cater for privacy and security concerns). These domain-specific language models may also include smaller transformer variants such as DistilBERT, TinyBERT, MobileBERT, ALBERT, or even task-specific encoder-decoder models trained on proprietary enterprise datasets. The self-evolving language model 110 may orchestrate these models in conjunction with the SGRM 120, the memory manager 122, and the self-reflection module 124 to optimize latency, cost, accuracy, and personalization, particularly in environmental settings that may need edge deployment, compliance with data privacy constraints, or efficient fine-tuning. Additionally, the modular nature of the self-evolving language model 110 may allow for flexible integration of diverse models, enabling adaptive response generation based on available resources, application domains, or complexity level of the input prompt 106.

According to some aspects, the user interface 104 may utilize the network 108 to communicate with the GenAI platform. The network 108 may include the public internet, private enterprise networks, switches, routers, firewalls, and secure virtual private network (VPN) tunnels. These network layers facilitate the secure and efficient exchange of data between the user interface 104 and the GenAI cloud platform.

Additionally, the GenAI cloud platform may encompass various cloud infrastructure environments and services, such as Oracle Cloud Infrastructure (OCI), Amazon Web Services (AWS), Google Cloud Platform (GCP), or Microsoft Azure. These cloud services may provide computational resources, storage, networking, and managed AI services to deploy, scale, and orchestrate the self-evolving language model 110 and its associated components. For instance, a cloud platform may leverage GPU-accelerated computation instances (e.g., AWS EC2 P4, Azure ND-series, or GCP A100 instances) for model inference engine, use serverless functions or container orchestration services (e.g., AWS Lambda, Azure Functions, Google Cloud Run, or Kubernetes) for dynamic workload management, and integrate with a native data storage or search engines (e.g., Amazon OpenSearch, Azure Cognitive Search, or GCP's Vertex AI Matching Engine) to support high throughput during external search tasks.

The GenAI cloud platform may further provide multi-tenant isolation, compliance support, and security features such as virtual private cloud (VPC) segmentation, encryption at rest and in transit, and identity and access management (IAM)-based access control to ensure safe, secure, and efficient execution of enterprise-grade generative AI workflows. Therefore, these platforms may provide the elastic computing resources that may be needed to serve the SELM 110 inference requests at scale. The GenAI platform may provide the user 102 with an access to the AI assistant or the one or more GenAI models implemented in the SELM 110 that is configured to generate content or the prompt response 126 based on the input prompt 106 received from the user 102.

According to the disclosed techniques, the input prompt 106 from the user 102 may be forwarded to the prompt processing unit 112 of the SELM 110. The prompt processing unit 112 may be configured to process the received input prompt 106 into a set of input tokens and corresponding embeddings. The prompt processing unit may first convert the natural language prompt into discrete sub-word units that can be independently processed. Subsequently, for each token, a corresponding embedding may be generated that may represent a semantic and syntactic meaning of each token of the set of input tokens in a continuous vector space, enabling the SELM 110 to capture contextual nuances. Additionally, positional encodings may be added to retain the order of the set of input tokens within the sequence, preserving the structure of the input prompt 106 for subsequent transformer-based computations. The generated input embeddings may be utilized by the transformer layers 114a-n for further processing.

According to some aspects, the input prompt 106 may be a part of a broader user interaction which may comprise multiple queries and corresponding responses or exchanges between the user 102 and the AI assistant backed by the SELM 110. Thus, at one point in time, an input prompt 106 may be a contradictory factual assertion, or a correction regarding a previously generated response of the SELM 110, a user-defined preference such as stylistic tone or domain specificity, a domain-specific task, or a research-oriented or exploratory question requiring up-to-date knowledge.

In some aspects, the SELM 110 may include multiple transformer layers 114a-n that may be configured to process the input prompt 106 at distinct representational depths or linguistic levels. Each transformer layer may comprise a dedicated memory pool that may be used while processing the input prompt at that layer. The memory pools 116a-n may store distinct sets of memory tokens along with their corresponding uncertainty scores. These uncertainty scores may be assigned either at the time of training, or when new candidate items may be added to the memory tokens because of real-time user interactions or external research processes. Furthermore, each transformer layer may be configured to compute a contextual similarity between each input token of the set of input tokens and the memory tokens using an attention mechanism to produce a set of memory-weighted tokens. The memory-attended tokens, in the present disclosure, may refer to a subset of memory tokens selected based on their contextual relevance to the input prompt, and are assigned based on a degree of contextual or semantic similarity with the input tokens using the respective attention scores. These memory-weighted tokens may subsequently be processed in real-time by the complementary components of the SELM 110 to determine if a memory update is needed or an external information retrieval source may be needed for generating an appropriate prompt response 126 corresponding to the input prompt 106.

The SELM 110 may incorporate or be coupled with the memory manager 122, the self-reflection module 124, and the SGRM 120, that may collectively function as core memory-oriented components with the LLMs or the language models. The memory manager 122 may be connected to the memory pools 116a-n associated with the transformer layers 114a-n and configured to process the memory-weighted tokens corresponding to the input prompt 106 to determine whether any memory adjustments may be needed or not. In some aspects, the memory manager 122 may be configured to detect or identify one or more candidate memory items for inclusion or replacement with the existing memory tokens that may be found to be obsolete, contradictory, or undetermined within the one or more memory pools corresponding to the one or more transformer layers 114a-n. The one or more candidate memory items may include a contextual insight, a user preference, an updated factual detail, an explicit contradiction, or a corrective signal highlighted by the user 102 in the input prompt 106. For example, if a user contradicts the model by saying “I heard the new iPhone has been set to release this month,” and the model finds no memory token reflecting the release timeline, the stated fact may be included as a new candidate memory item. In some other aspects, a memory token may be found but contain a conflicting statement, such as “the release date is set to be two months from now,” and hence may be associated with a high uncertainty score. In this case, the memory manager 122 may store the user-provided fact as a new memory token with an initially moderate or high uncertainty score, or replace the obsolete memory token, or retain both versions while simultaneously adjusting the uncertainty score of the older token to reflect that its information might be ambiguous or obsolete.

Since each memory pool of the one or more memory pools 116a-n may include different sets of memory tokens and may serve a distinct layer specific to a given context, the candidate memory items (or tokens) may not be uniformly distributed or propagated across all the memory pools 116a-n. Instead, such tokens may be included or replaced in only one or more of the memory pools 116a-n, depending on the attention relevance, semantic scope, or representational depth of each layer. For example, a token representing a high-level conceptual update may only be integrated into deeper transformer layers that may do global reasoning, whereas surface-level linguistic preferences may be updated in the initial layers. Simultaneously, one or more memory tokens that are associated with high uncertainty scores may be removed from each memory pool. This token-level filtering may enhance available memory capacity by discarding information that may be deemed as ambiguous, obsolete, or redundant. In some aspects, uncertainty scores may be dynamically managed and adjusted by the memory manager 122 based on a correction frequency or an observed consistency of the factual usage across multiple queries.

According to the disclosed techniques, the memory-weighted tokens, derived from the transformer layers 114a-n, may also be assessed by the SGRM 120 in real-time to detect a potential knowledge gap in the internal memory (i.e., the memory pools 116a-n) of the SELM 110, enabling an identification of deficiencies in the current knowledge base. Based on the detection, the SELM 110 may autonomously update its internal memory prior to generating a response to the input prompt 106. This may enable accurate, reliable responses without relying on outdated, incomplete, or hallucinated content. If a memory-weighted token exhibits weak contextual alignment—for instance, having a small number of relevant memory tokens or being associated with uniformly low attention weights across all relevant memory tokens—then a knowledge gap may be inferred.

Upon detection of the knowledge gap, the SGRM 120 may trigger a function call to an external research agent that may be configured to access one or more external, web-based data sources or domain-specific knowledge repositories. One or more query-relevant textual responses may be retrieved from the external data sources and forwarded to the SGRM 120. The SGRM 120, in turn, may validate the retrieved content and convert the textual data into a structured format (e.g., key-value pairs, entity-relation triples, or token sequences) using one or more natural language processing (NLP) techniques. Subsequently, the SGRM 120 may initiate a memory update request to the memory manager 122, instructing it to integrate the validated external content as the candidate memory items into one or more memory pools, associated with one or more transformer layers of the SELM 110, to not only close the knowledge gap but also refine future responses.

Based on the updated memory pools, the SELM 110 may generate contextualized embeddings corresponding to the input prompt 106 by utilizing the transformer layers 114a-n that may now implement an attention mechanism (i.e., the self-attention mechanism. the multi-head, or the cross-attention mechanism) using the memory tokens from the updated memory pools. Each transformer layer may retrieve a contextually relevant subset of memory tokens from its associated memory pool and assign attention weights based on their semantic alignment with each token of the set of input tokens. The attention weights, in this process, may be guided by the uncertainty scores associated with each memory token of the one or more memory tokens that may have been found relevant to the input prompt 106. Following the generation of the contextualized embeddings, the SELM 110 may forward these embeddings to the one or more downstream model components 118, configured to generate a final prompt response 126. The one or more downstream model components 118 may include one or more decoder layers, one or more output projection layers, and one or more language modeling heads, configured to decode the contextualized embeddings into a fluent and contextually appropriate natural language responses. These model components may also include response optimization units for applying grammar correction, politeness tuning, domain adaptation, or sentiment alignment based on users' prior interactions.

Finally, the generated prompt response 126 may be transmitted to the user 102 via the UI 104. Consequently, the disclosed SELM 110 may enable advanced natural language interaction by dynamically refining its internal knowledge through a self-reflection mechanism and an external research integration mechanism. This self-updating capability may reduce operational overhead, eliminate the dependency on static corpora or on RAG mechanisms, allowing the model to remain updated with the information associated with the real-world developments—all orchestrated within a scalable, cloud-native infrastructure.

According to some aspects, after each user interaction concludes, the self-reflection module 124 may be initiated. The self-reflection module 124 may be configured to review the complete conversation histories across a plurality of users 102 to detect insights, preferences, factual updates, corrections, or contradictions that may be shared or liked by one or more users of the plurality of users 102. The self-reflection module 124 may analyze such interactions retrospectively to identify consistent signals, such as commonly requested factual updates or emerging domain-specific terminologies, that may not have been captured earlier during real-time interactions. Moreover, the self-reflection module 124 may first validate and synthesize the detected insights across the user base, then initiate a memory update request to the memory manager 122 to incorporate the insights into the one or more memory pools as candidate memory tokens. As a result, the SELM 110 may adapt to changing market trends, evolving user preferences, regulatory updates, emerging terminologies, corrected factual knowledge, and real time user feedback without the need of retraining or manual interventions.

According to some aspects, the SELM 110 may also implement a validation and guardrails engine (VGE) 128 that may be configured to interface with the self-reflection module 124, the memory manager 122, the SGRM 120, and the one or more downstream model components 118. The VGE 128 may be configured to monitor and validate the internal reasoning, memory updates, external content integration, and output generation of the SELM 110, in accordance with a set of predefined validation criteria and safety protocols (referred to herein as “guardrails”). The guardrails enforced by the VGE 128 may include, for example, factual correctness, domain consistency, contextual coherence, response reliability, and safety constraints. In some aspects, the safety constraints may also include one or more conditions to detect inappropriate, harmful, or insensitive user prompts that may either not be responded to or be responded to with extreme caution, using one or more predefined mitigation strategies. In some aspects, the guardrails may be implemented using one or more lightweight classification models trained to detect various issues such as hallucinations, unsafe or biased outputs, or legally and ethically sensitive responses. The classification models may be fine-tuned on labeled datasets comprising factual inconsistencies, offensive or discriminatory language, and violations of domain-specific compliance rules (e.g., misdiagnosis in healthcare, advise to invest substantial risk derivatives etc.). To enforce compliance, one or more rule-based mechanisms may be configured based on domain-specific policies, such as medical guidelines, financial compliance constraints, or legal risk boundaries. These mechanisms may be used to flag or block outputs that may deviate from the acceptable professional norms defined by domain experts of these domains. The combination of these classification models and rule-based mechanisms may enable the VGE 128 to oversee and evaluate generated responses, memory updates, and externally retrieved content before their integration to the memory pools 116a-n of the SELM 110.

For instance, upon identifying the need for one or more insights or one or more updates, by the self-reflection module 124 or the memory manager 122, the VGE 128 may validate these updates and insights against safety and fact check guardrails before authorizing the update. Similarly, upon retrieval of external data by the SGRM 120, the VGE 128 may screen the retrieved content for domain relevance, reliability, and compliance prior to its integration into the memory pools 116a-n. Furthermore, before any output is delivered to the user 102, the VGE 128 may perform a final validation of the response generated by the model. This may include assessing whether the response is aligned with the contents of the internal memory and does not contain harmful, misleading, or fake information, and also adheres to the safety protocols and guidelines. In some aspects, if the VGE 128 may identify a safety or reliability violation, it may block the response or instruct the SELM 110 to regenerate an alternate, safer output.

In some aspects, a language model because of its method of implementation of one or more safety guardrails may be configured to refuse generating responses to queries or prompts from various users that it may identify as potentially unsafe, harmful, or sensitive. But in certain situations, these guardrails may cause the model to refuse generating responses to queries that are, in fact, safe and appropriate. Such instances, referred to herein as “harmful refusal rates,” may lead to users' dissatisfaction, reduced model trust and utility, or the unintended denial of access to valuable information. Accordingly, the validation and guardrails engine (VGE) 128 may be configured to reduce harmful refusal rates (i.e., the frequency with which the model inappropriately refuses to respond to useful requests or prompts) by distinguishing between genuinely unsafe queries and those that are safe and suitable for generating a response.

According to some aspects, the VGE 128 may utilize one or more fine-tuned machine-learning (ML) models trained on datasets specifically labeled for harmful refusals, toxicity, bias, hallucinations, misinformation, and ethical concerns. Thus, the VGE 126 may operate as a meta-level quality control and safety validation module, allowing the SELM 110 to function as a trustworthy, regulation-aware, and safety-aligned AI model across user-facing conversations and self-evolved memory operations.

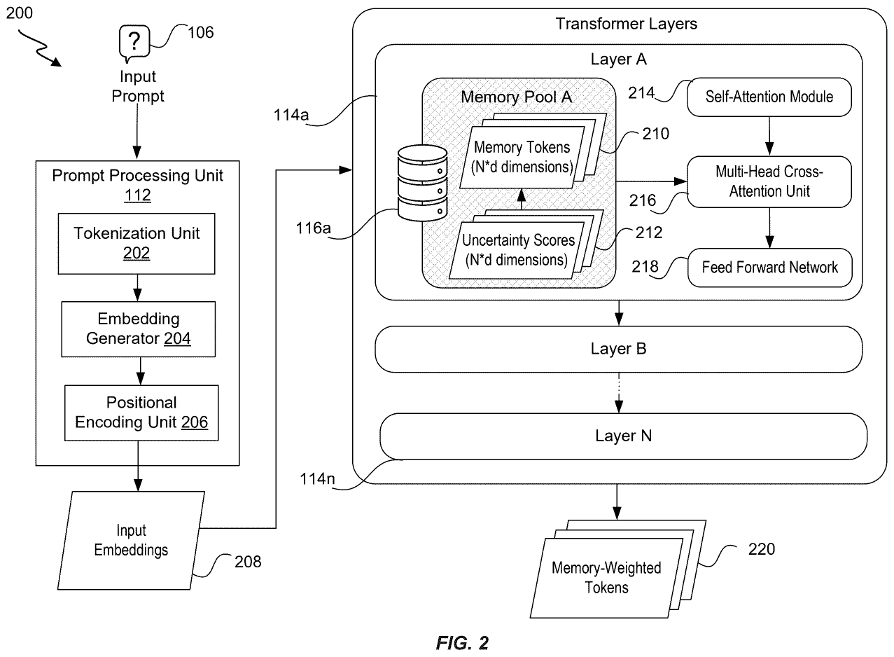

FIG. 2 illustrates an exemplary block diagram of a prompt processing unit for generating a set of memory-weighted tokens corresponding to the input prompt, in accordance with some aspects of the present disclosure. The prompt processing unit 112 may comprise a tokenization unit 202, an embedding generator 204, and a positional encoding unit 206. Moreover, the transformer layers 114a-n may include a plurality of transformer layers, each of which may include a dedicated memory pool 116a, a self-attention module 214, a multi-head cross attention unit 216, and a feed forward network (FNN) 218. The memory pool 116a may include a set of memory tokens 210 stored along with their associated uncertainty scores 212.

According to some aspects, the input prompt 106 may be forwarded to the prompt processing unit 112 that may be configured to convert the input prompt 106 into a set of input embeddings 208. The tokenization unit 202 may convert the input prompt 106 into the set of input tokens that may subsequently be converted into a corresponding input embedding (i.e., an embedding representation) using the embedding generator 204. Furthermore, each of the generated embeddings may be complemented with positional encoding using the positional encoding unit 206 that may be configured to inject sequence-level information into the otherwise position-agnostic input embeddings. A positional encoding, in the present disclosure, may refer to a fixed or learnable vector that may encode the relative or absolute position of each input token in a sequence, allowing the downstream components of the SELM 110 to capture the order and structure of the input prompt 106. Moreover, the positional encodings may be added to the input embeddings to preserve syntactic and semantic dependencies across tokens, which are crucial for understanding natural language input in a transformer-based model. The output of the prompt processing unit 112 (i.e., the input embeddings 208) may be forwarded to the transformer layers 114a-n for further processing.

According to the disclosed techniques, each transformer layer may comprise dedicated attention mechanism components that may be configured to process the input embeddings 208 sequentially by leveraging the memory pool associated with that layer. As depicted in FIG. 2, a transformer layer 114a may comprise the memory pool 116a that may further include a set of memory tokens 210 of an (N×d) dimension. Here, “N” denotes the number of memory tokens and “d” represents the dimensionality of each embedding vector corresponding to the memory tokens 210. For instance, if there are 10 memory tokens and each is 768-dimensional vector, the memory pool for that layer would be a matrix of (10×768) dimension.

According to some aspects, each memory token may have an associated uncertainty score 212, which may also be stored within the memory pool alongside the memory token 210, in the form of (N×d) vector or matrix. Therefore, instead of assigning a single scalar uncertainty value per memory token, the uncertainty score 212 may be represented as a vector of length d, aligned with the dimensional structure of the corresponding memory token 210. Each element of the uncertainty vector may quantify the model's confidence in a specific semantic dimension of the memory token's embedding. Consequently, each feature dimension of a memory token—such as its syntactic attributes, domain specificity, temporal context, or factual grounding—may have a separate uncertainty level. The representation of the uncertainty score 212 in this manner may allow the SELM 110 to exhibit high confidence in certain semantic aspects of a memory token (e.g., domain category) while being less certain about others (e.g., temporal accuracy or factuality). For instance, for a memory token encoding knowledge about a medical condition such as hepatitis B in a 768-dimensional embedding, a subset of dimensions of the embedding (e.g., dimensions 1-128) may predominantly encode domain-stable information, such as the fact that the disease is caused by the hepatitis B virus, that it primarily affects liver tissue, or that it can be diagnosed via serological markers. Another subset of dimensions (e.g., dimensions 600-768) may correspond to temporal or context-sensitive information, such as the latest recommended antiviral therapy, recently updated dosage guidelines, or current prevalence rates in a particular region. In this case, the uncertainty vector may reflect lower uncertainty scores for the stable biological dimensions while assigning higher uncertainty scores to the temporal or epidemiological dimensions. Such a representation may allow the SELM 110 to preserve invariant medical knowledge while selectively updating only the time-sensitive components when new clinical guidelines or outbreak data become available. Moreover, this representation may also enable a granular attention computation during the memory-attention phase while generating a response, whereby input tokens may selectively attend to the memory tokens 210 not only based on contextual relevance but also dimension-wise uncertainty. Additionally, the vector-based uncertainty representation may enhance the accuracy of the SELM 110 for identifying the input tokens for a memory update, determining whether the input tokens may have information that may not align with the memory tokens or contradict uncertain or obsolete memory contents.

Some technical advantages of having both the memory tokens 210 and the uncertainty weights 212 in a vector representation may be: (1) the memory manager 122 may not have to remove or replace the complete tokens stream in the memory during the memory update process; (2) the memory manager 122 may only have to update a portion or replace individual vector elements based on their corresponding uncertainty scores 212, as only a portion of its embeddings are marked as uncertain. Moreover, since the attention mechanism may involve a matrix multiplication between a key, a value, and input token embedding (each represented in (N×d) dimensions), storing the uncertainty scores 212 in the same dimensional space may allow a discrete modulation or gating of attention outputs for each dimension. This may result in a precise computation of contextual relevance or token-level alignment, improving the factual accuracy of the model at the inference time.

The transformer layers 114a-n, which may include the self-attention module 214, the multi-head cross attention unit 216, and the FNN 218, may be configured to generate the contextualized embeddings (also referred to herein as memory-weighted tokens 220) corresponding to the input embeddings 208. According to some aspects, the memory-weighted tokens 220 may refer to a set of prompt-relevant memory tokens from the total memory tokens 210 that are deemed contextually relevant to the input tokens. The multi-head cross attention unit 216 may be configured to compute a contextual relevance between each input token and the memory tokens 210. Based on this similarity, the multi-head cross attention unit 216 may identify the set of prompt-relevant memory tokens and assign to each memory token in the set an attention weight, representing a degree of semantic or contextual relevance with respect to the corresponding input token. Similarly, each subsequent transformer layer may sequentially process the input prompt 106 using its own associated memory pool (each memory pool of the set of memory pools 116a-n comprising disjoint or distinct set of memory tokens 210), and independently apply the multi-head cross attention mechanism to generate a corresponding set of memory-weighted tokens 220. These intermediate outputs may be aggregated progressively across the transformer layers 116a-n, whereby each transformer layer's output may contribute to enhance the contextual enrichment based on the cumulative memory-weighted representation of the input prompt 106. According to some aspects, the memory-weighted tokens 220 may represent a set of enriched token embeddings, including the original input token representations that may have been modulated by and fused with relevant contextual information (i.e., the set of prompt-relevant memory tokens) that may have been retrieved from the internal memory pools 116a-n. This may facilitate early-stage evaluation of an alignment or divergence of the input prompt 106 with respect to a current memory state of the SELM 110 prior to generating a final prompt response 126.

Finally, the resulting memory-weighted tokens 220 may be accessed by or forwarded to the memory manager 122 and the SGRM 120 for further evaluation, including detecting knowledge gaps, identifying novel insights, or determining whether a real-time memory update is warranted based on the received input prompt 106.

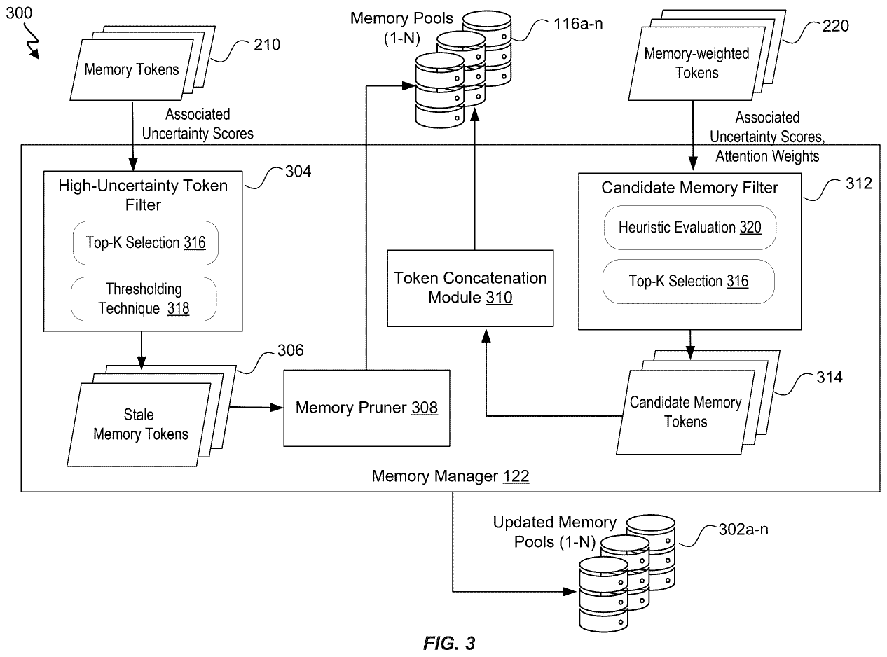

FIG. 3 illustrates an exemplary block diagram of the memory manager 122 for updating one or more memory pools associated with one or more transformer layers in accordance with some aspects of the present disclosure. The memory manager 122 may include a high-uncertainty token filter 304, a memory pruner 308, a candidate memory filter 312, and a token concatenation module 310. According to some aspects, the candidate memory filter 312 may employ one or more filtering techniques to identify or filter, from the memory-weighted tokens 220, a subset of candidate memory tokens 314, representing one or more new facts the model may have not previously unseen in its stored memory tokens 210.

The one or more filtering techniques may include heuristic evaluation 320, or a top K selection 316, entropy-based ranking, SoftMax-based thresholding, or percentile cutoffs. In some aspects, the one or more filtering techniques may be implemented using one or more machine-learning (ML) models such as logistic regression, support vector machines (SVM), random forests, gradient boosting machines, deep neural networks (i.e., CNN or RNN), or transformer-based classifiers. The filtering process may involve analyzing the memory-weighted tokens 220 based on the assigned attention weights in combination with their associated uncertainty scores 212 based on one or more predefined heuristics conditions.

The heuristic conditions may include, for example, a condition that if an input token gets an exceptionally low contextual relevance score from the memory tokens 210 (i.e., the contextually relevant memory tokens found even marginally relevant to the input token are assigned low attention weights). and if the majority of these contextually relevant memory tokens have low uncertainty scores (i.e., typical scores for reliable or trusted memory tokens), the input token may be inferred as a new or unknown fact that the model may have not previously observed in the training data. Another heuristic condition may be that if an input token is associated with one or more memory tokens with high attention weights based on their contextual relevance, but the majority of these memory tokens may have high uncertainty scores 212, implying that the input token may contradict or challenge the unreliable or weakly trusted knowledge currently stored in the memory pools 116a-n. Accordingly, in both conditions, the candidate memory filter 312 may flag the input token as a candidate memory token for inclusion in the model's internal memory. Similarly, the filtering process may be applied to each input token of the set of input tokens corresponding to the input prompt 106, and the resulting set of candidate memory tokens 314 may be further refined to a smaller subset of top-ranked or most significant tokens using the top K selection 316.

The filtered candidate memory tokens 314 may be forwarded to the tokens concatenation module 310 that may either append or replace the candidate memory tokens 314 with the existing memory tokens 210 in the one or more memory pools 116a-n. Since the memory pools 116a-n may comprise distinct and layer-specific sets of memory tokens 210, only one or more of the memory pools 116a-n may be selected for an update based on the transformer layers 114a-n that may have originally processed the relevant input tokens or exhibited weak memory alignment during attention computation phase. For example, if a contradiction or a new fact is identified in the memory tokens of the transformer layer 114b, then only memory pool 116b may be updated and others remain unchanged. This selective update mechanism may allow the SELM 110 to maintain localized and semantically specialized memory within each transformer layer 116a-n, avoiding redundant updates across all layers and preserving the integrity of previously learned context.

According to some aspects, the high-uncertainty token filter 304, working in tandem with the candidate memory filter 312, may be configured to access the memory tokens 210 stored in each memory pool of the memory pools 116a-n to dynamically filter a subset of memory tokens (i.e., stale memory tokens 306) that may have relatively high uncertainty scores 212 in comparison to the other memory tokens 210 in the corresponding memory pool 116n.

The filtering may be performed by implementing the one or more filtering techniques, such as the top K selection 316, or one or more thresholding techniques 318. The one or more thresholding techniques 318 may include entropy-based ranking, SoftMax-based thresholding, or percentile-based cutoffs. The filtering may be applied using the one or more ML models similar to those mentioned within the high-uncertainty token filter 304 (i.e., logistic regression, support vector machines (SVM), random forests, gradient boosting machines, deep neural networks (i.e., CNN or RNN), or transformer-based classifiers). High uncertainty scores may be indicative that a corresponding memory token is obsolete or irrelevant. In some aspects, the uncertainty scores 212, associated with one or more memory tokens, may be updated or adjusted to reflect the current uncertainty status. For example, if a user contradicts or corrects a fact, previously generated by the model, the uncertainty score of the memory token corresponding to the corrected fact may be incremented. This may result in oscillating uncertainty scores 212 in the memory pools 116a-n. Subsequently, the memory manager 122 may be configured to iteratively—or after every predefined time interval—perform the filtering of the stale memory tokens 306 to not only purge the obsolete information but also to create a room for new candidate memory tokens 314.

The filtered set of stale memory tokens 306 may be sent to the memory pruner 308 that may be configured to remove or exclude the stale memory tokens 306 from their corresponding memory pools 116a-n. This exclusion process may help maintain the relevance, reliability, and compactness of the memory pools over a period. In some aspects, the memory pruner 308 may operate in conjunction with the high-uncertainty token filter 304 to continuously manage memory hygiene by purging the memory tokens that are no longer relevant or useful for generating accurate, up-to-date responses. Subsequently, the memory manager 122 may update the one or more memory pools (referred to herein as the updated memory pools 302a-n) using the memory pruner 308 and the tokens concatenation module 310.

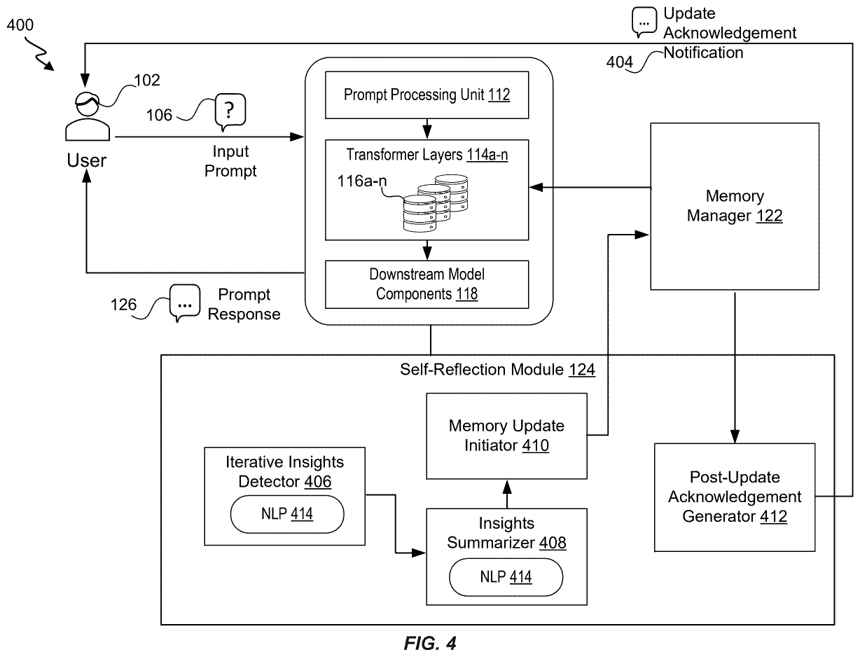

FIG. 4 shows a block diagram of the self-reflection module 124 for detecting one or more insights from a user interaction in accordance with some aspects of the present disclosure. The self-reflection module 124 may include an iterative insights detector 406, an insights summarizer 408, a memory update initiator 410, and a post-update acknowledgement generator 412. The self-reflection module 124 may be configured to assess or evaluate the complete conversation or exchanges between the user 102 and the model, which may include one or more input prompts 106 submitted by the user 102 and their corresponding responses (i.e., the prompt response 126), generated by the one or more downstream model components 118 within an interaction session or conversation.

According to the disclosed techniques, the self-reflection module 124 may be implemented to complement the memory manager 122, configured to dynamically analyze each interaction with a user by revisiting an entire conversation history, and identifying one or more insights or potentially valuable information provided by the user 102. The detected insights may then be forwarded to the memory manager 122 that may ingest the insights into one or more memory pools 116a-n. Therefore, the self-reflection module 124 may detect new insights or useful patterns that may emerge in a conversation or an interaction session, the SELM 110 may autonomously update its internal memory (i.e., the memory pools 116a-n) by invoking function calls to encode the new information, allowing the model to retain a meaningful exchange in its internal memory and use the updated memory to manage future interactions between users and the model. This may enable the SELM 110 to progressively improve its understanding and responses by learning from one or more user interactions with the model. This ability of the SELM 110 may be especially valuable for applications demanding adaptive learning and memory retention, as the model may seamlessly incorporate and ingest new knowledge.

According to some aspects, the iterative insights detector 406 may be activated after the model responds to an input prompt 106 by generating the prompt response 126 to the user 102, specifically in iterative dialogue scenarios, comprising multiple exchanges between the user 102 and the model. For example, a user may provide an initial prompt, such as “I heard that Europe Union (EU) recently passed new AI regulations that could impact AI companies significantly,” to which the model may respond, “Yes, the EU has been proactively enacting AI safety and data privacy laws. Is there a recent update on this topic?” The user may then respond with, “Yes, the EU parliament has recently passed the AI Act, which includes regulations around high-risk AI applications and transparency requirements.” In response, the model may state, “That's a significant step! I understand that high-risk AI system may include systems for healthcare and finance. Did they set specific rules that may demand systems to transparently show reasons behind their inferences?” Subsequently, the user may reply with a clarification prompt such as, “You nailed it. The AI Act now requires AI systems to disclose when AI inference is used and reasons or interpretations behind the inference, especially in domain that may infringe on human rights or bring harm. This practice may set a precedent for other countries to follow.”

In such cases, the iterative insights detector 406 may be configured to traverse through a conversation history, by using one or more natural language processing (NLP) techniques 414, and identify that the user is providing a novel, time-sensitive factual insight related to the recent passing of the EU AI Act. For example, based on the model's response “Is there a recent update on this topic?” and follow-up queries about transparency rules, the iterative insights detector 406 may infer that the information provided by the user is not known to the model, as this information is not in its training data. The one or more NLP techniques 414 that may detect new information may include semantic similarity analysis, named-entity recognition (NER), topic modeling, and coreference resolution across various user inputs and subsequent responses of the model during live interactions between the users and the model. Based on these assessments and evaluations, the iterative insights detector 406 may isolate the user's factual input about the EU AI Act as a meaningful insight for updating the content in the relevant memory pools 116a-n.

According to some of the disclosed techniques, the one or more NLP techniques 414 may further include clustering, configured to group semantically similar insights or conversation segments into clusters, thereby preventing redundant or repetitive ingestion of equivalent information into the memory pools 116a-n. The one or more NLP techniques 414 may additionally include contradiction detection, configured to evaluate whether a newly detected insight conflicts with previously ingested information or earlier statements in the same conversation, allowing the self-reflection module 124 to flag, reconcile, or replace inconsistent information before forwarding it to the memory manager 122.

Subsequently, the insights summarizer 408 may generate a distilled insight, such as “The EU recently passed the AI Act, regulating high-risk AI systems, applications, and mandating transparency for providing reasons for their inferences. This may influence global trends in the domain of regulating AI Systems.” The generated summary may then be tokenized into keywords such as “EU AI Act,” “transparency,” “high-risk AI,” “interpretability,” “explainable AI,” or “regulation” that may be flagged as one or more candidate memory tokens 314. Since the insight is absent from the existing content of the memory pools 116a-n, the memory update initiator 410 may forward it to the memory manager 122. The memory manager 122 may then include or add the forwarded one or more tokens in the relevant (one or more) memory pools 116a-n or replace one or more previously stored memory tokens 210 found to be obsolete.

Finally, the post-update acknowledgment generator 412 may be configured to generate a notification or an acknowledgment response to the user 102 indicating that the information or the insight has been received and updated in the memory of the model and will be available for a future reference. For instance, the model may respond with a message such as: “I've noted a recent information about the EU AI Act for reference in regulatory discussions.” This post-update acknowledgment 404 may foster transparency and reinforce the adaptive behavior of the SELM 110 in response to user-shared sources of knowledge and information.

In another example, a user may provide a more personalized input, such as “I'm switching from a finance background to data science.” The self-reflection module 124 may identify this as a user-specific insight and summarize it as a context or preference shift that could assist in tailoring future responses, such as recommending beginner-friendly machine-learning resources or adjusting the technical depth of explanations to various queries related to the field of data science when the user asks for it.

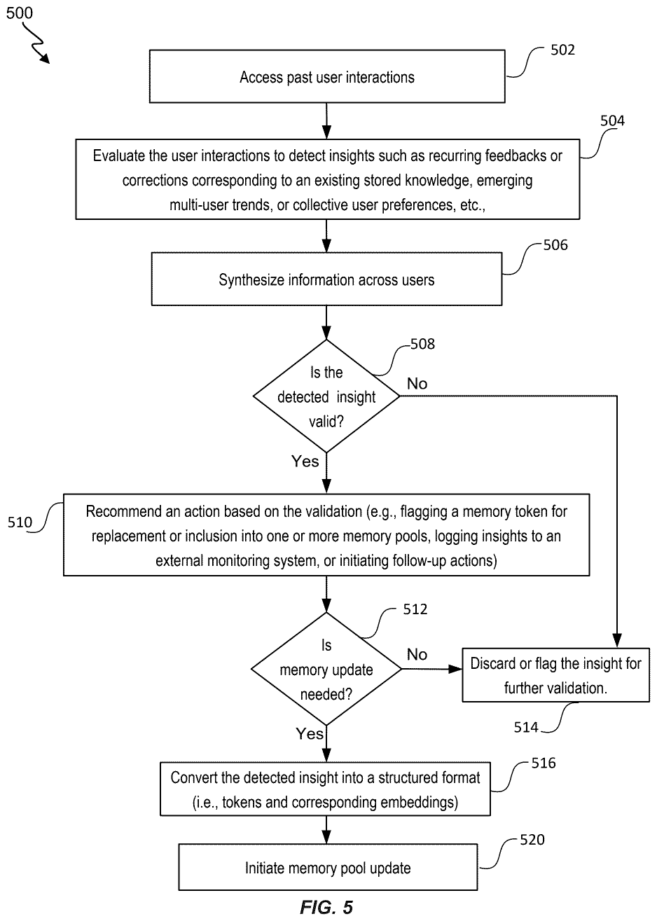

FIG. 5 shows an example flowchart of a model for validating one or more insights and performing a corresponding action in accordance with some aspects of the present disclosure. According to some aspects, the self-reflection module 124 may validate a detected insight before flagging it safe for adding or including in the internal memory of the model. The validation process may involve synthesizing the detected insight across multiple users to determine whether the insight is sufficiently important, accurate, or widely reported. Notably, the validation may not just be constrained to a per-user reflection; rather, it may be performed as a meta-level or cross-user insight mining process. Additionally, the validation process may run asynchronously or in batches, whereby the self-reflection module 124 may aggregate and analyze patterns emerging from multiple independent user interactions. For instance, if fifty or more users mention the recent enactment of a global AI regulatory agenda, or if many users inquire about the discontinuation of a widely used open-source library, the self-reflection module 124 may detect a recurring trend or shared context. In another example, if users from different regions report updates to visa policies for international students, the model may infer a global interest in visa policies of various countries and tag it to education and immigration domains.

In some implementations, the validation process may employ clustering algorithms (e.g., hierarchical clustering, k-means, or density-based clustering) to group semantically similar insights derived from different users. Such clustering may enable the self-reflection module 124 to detect recurring patterns and consolidate redundant or overlapping information. Additionally, contradiction detection techniques may be applied by computing semantic similarity scores between candidate insights and identifying conflicting claims (e.g., one user reporting a fact as true while another negates it). Contradictory insights may trigger further weighting or suppression rules to prevent inclusion of unreliable tokens into the internal memory. Furthermore, a confidence aggregation mechanism may be employed, wherein each candidate insight may be assigned a composite reliability score based on factors such as frequency of occurrence across users, semantic consistency within a cluster, and alignment with high-certainty memory tokens already stored in the internal memory. Insights with scores above a predefined threshold may be flagged as safe for integration, while those below may be discarded or deferred for further evaluation. Therefore, the cross-user insight mining may enable the SELM 110 to detect emerging patterns in user concerns, evolving technical norms, domain-specific shifts, or broader societal and market trends.

Furthermore, the validation process may also determine whether the detected insight (or new information) may genuinely warrant its inclusion (or addition) in the internal memory. Consequently, not every insight may necessitate a persistent memory update. For example, if multiple users ask how to switch the model's output language from English to Spanish, or request formatting guidance for a résumé, these may be treated as session-specific preferences rather than insights that may need a long-term retention. Similarly, user-specific cues or situational prompts may be deemed non-generalizable and hence excluded from the global memory update process of the relevant memory pools 116a-n.

At process 502, one or more past user interactions associated with multiple users 102 may be accessed from one or more stored conversation histories. These interactions may include prior input prompts 106 and corresponding prompt responses 126 generated by the model that may have been exchanged across multiple dialogue sessions. At process 504, the accessed interactions may be evaluated to identify or detect one or more insights. The detected insights may include: (1) recurring feedback, referring to repeated corrections or contradictions submitted by different users in response to the same factual information previously generated by the model (e.g., multiple users correcting an incorrect release year of a product or wrong attribution of a law); (2) emerging multi-user trends, such as a rise in users' interest about a newly released technology or regulation; or (3) collective preferences, such as consistent requests for concise responses or visual summaries.

At process 506, the self-reflection module 124 may synthesize the detected insights across various users by performing a semantic and contextual comparison of similar responses or corrections, using one or more NLP techniques 414 such as clustering, sentence embedding comparisons, contradiction detection, or keyword-based aggregation. “Synthesizing” in the present context may refer to a process of consolidating various insights that may overlap or be thematically related, identifying those that may be frequently or consistently asked across separate user interactions, and filtering out outliers or individual preferences that may not reflect broader population level patterns and trends.

Based on the synthesis, at process 508, it may be determined whether a detected insight is valid or not. The validation may determine if the detected insight satisfies one or more validity thresholds—such as a frequency threshold, a consistency threshold, or a reliability threshold—indicating that it may not just be user-specific but rather a generalized or commonly observed insight. For instance, if the detected insight corresponds to a widely reported factual correction, a newly surfaced regulation, or a significant change in collective users' preferences, the insight may be flagged to be included or added to the internal memory of the model. Subsequently, at process 510, an appropriate action may be recommended based on the validation outcome. Possible actions may include, for example, flagging one or more memory tokens for replacement or inclusion into one or more memory pools of the memory pools 116a-n, or logging the insight to an external monitoring or analytics system. Alternatively, at process 514, if the insight does not meet the validity criteria, it may either be discarded or temporarily cached for further validation based on additional users' interactions.

At process 512, it may be determined whether to update the internal memory with the new insight, based on the recommended action. In case the insight is to be included or added to the internal memory, the validated insight may be converted into a structured format—such as a tokenized text and corresponding embedding representations—based on the internal token representation schema of the memory pools 116a-n, at process 516. Otherwise, at process 514, the validated insights may be discarded or flagged for further validation. Finally, at process 520, a memory update process may be initiated by triggering the memory manager 122 that may incorporate the newly generated tokens (and their associated embeddings) into one or more memory pools of the memory pools 116a-n, either by appending them or replacing previously stored memory tokens 210 that may have become obsolete or have high uncertainty scores 212.

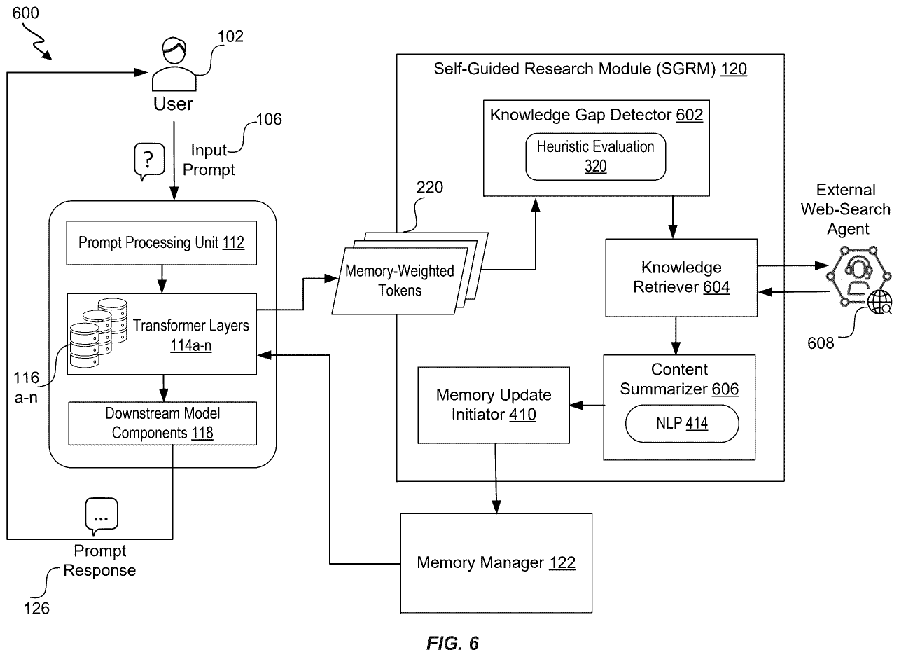

FIG. 6 shows a block diagram of the self-guided research module (SGRM) 120 for detecting a knowledge gap based on the input prompt 106 and retrieving external content for updating the one or more memory pools 116a-n. The SGRM 120 may include a knowledge gap detector 602, a knowledge retriever 604, a content summarizer 606, and the memory update initiator 410.

According to some aspects, the SGRM 120 may be implemented by the SELM 110 to determine whether an acceptable or adequate amount of information exists within the internal memory to adequately address a research-oriented query from the user 102, based on one or more predefined heuristic conditions. If the internal memory comprises information that may be obsolete or irrelevant, this may a sign of a significant knowledge gap in a given domain. Based on this determination, the SGRM 120 may retrieve external information related to the input prompt 106 and update its internal memory by integrating the retrieved information into one or more memory pools before generating a response to the user 102.

According to some aspects, the heuristic evaluation 320 may determine that if a majority of input tokens are attended by fewer than a predefined threshold number of contextually relevant memory tokens during the attention computation phase, a knowledge gap may exist. This knowledge gap may be indicative of a fact that in a given domain, it may not be possible to generate the response of the input prompt 106, or the memory pools 116a-n may lack information that may be contextually relevant the input tokens. Furthermore, if the assigned attention weights between the input tokens and the corresponding contextually relevant memory retrieved tokens fall below a threshold value and the majority of these memory tokens have relatively high uncertainty scores, then it may be inferred that the information in the internal memory pertaining to the input prompt may be either irrelevant or obsolete.

For instance, a research-related user prompt such as “What are the latest breakthrough papers, inventions, or models in the domain of zero-shot multimodal learning published until now in 2025?” may involve research literature and model development activities that may not have been in the training data of the model. Based on the outcome of the heuristic evaluation 320, the knowledge retriever 604 may initiate a function call to interface with an external web-search agent 608. The external web-search agent 608 may have access to one or more external data repositories, publicly available databases, knowledge bases, web documents, or authoritative content sources. Consequently, the external web-search agent 608 may retrieve relevant information content corresponding to the input prompt 106. The retrieved information content may then be transmitted to the knowledge retriever 604 for further processing.

According to some aspects, the content summarizer 606 may be configured to distill, merge, or compress the externally retrieved data content into a condensed and structured form. The processed data content may subsequently be tokenized and transformed into corresponding embeddings, in accordance with a token representation schema specific to the SELM 110, to yield a structured format compatible that may be compatible with the architecture of the memory pools 116a-n. The summarization and transformation may be performed using the one or more NLP techniques 414 that may include named entity recognition (NER), keyphrase extraction, topic modeling, and semantic similarity analysis. Subsequently, the memory update initiator 410 may flag the resulting tokens, along with their corresponding embedding representations, as the candidate memory tokens 314, which may then be forwarded to the memory manager 122. The memory manager 122 may selectively include or replace these candidate memory tokens 314 in the one or more of the memory pools 116a-n, associated with the respective transformer layers 114a-n, using the token concatenation module 310.

Once the internal memory of the SELM 110 may have been enriched with the newly retrieved and processed data content, the transformer layers 114a-n (now updated with contextually relevant, up-to-date memory tokens) may be utilized in conjunction with the one or more downstream model components 118 to generate the final prompt response 126. This dynamic, on-the-fly memory update method in the SELM 110 may offer several technical advantages: (1) it may allow the SELM 110 to integrate current and emerging information nearly in real-time without requiring full model retraining or offline fine-tuning processes; (2) its computational overhead may be significantly reduced because the memory updates include refreshing embeddings only and these updates may occur in a modular fashion at the transformer-level and include (i.e., eliminating the need for retraining to update all internal weights of the model), enabling the SELM 110 to incorporate latest information; (3) it may also improve the relevance and fact checking of generated responses, especially in various domains that are subject to frequent updates (i.e., policy, regulation, scientific advancements, or technological trends); and (4) the model may maintain a more compressed and continually evolving knowledge base (i.e., the internal memory) tailored to users' interactions that may enhance memory efficiency, reduce storage redundancy, and enable personalization or domain adaptation. By updating the internal memory with external search outputs in a structured and semantically aligned format, the SELM 110 may continually enhance its adaptability, long-term consistency, and resilience when knowledge in its memory pools 116a-n become obsolete or irrelevant.

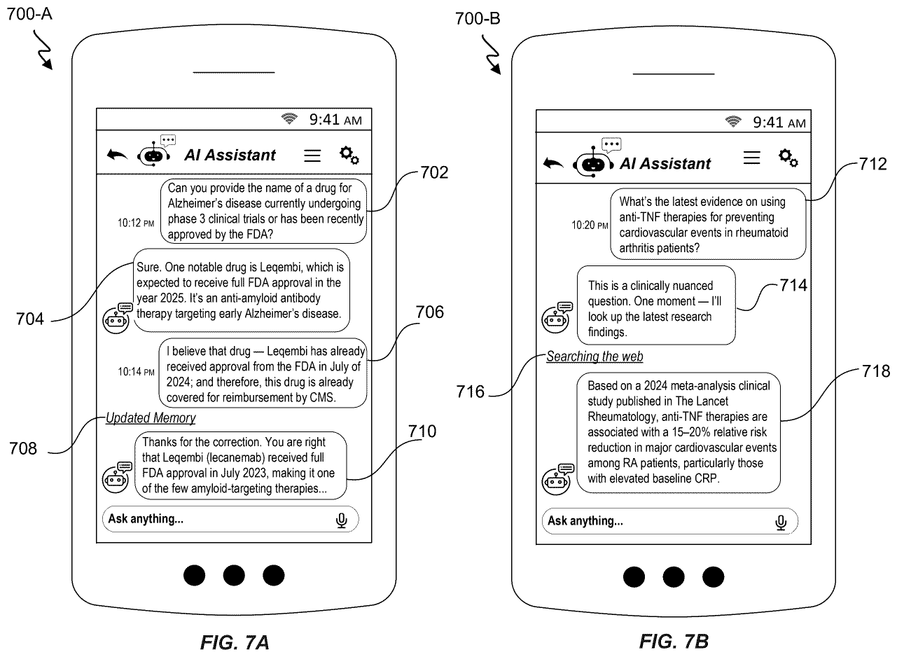

FIG. 7A illustrates an exemplary user interface (UI) 700-A displaying a sequence of dialogue exchanges between a user and an interactive artificial intelligence (AI) assistant, in accordance with some aspects of the present disclosure. The UI 700-A may depict a dashboard or a conversational screen associated with the interactive AI assistant. As illustrated, the user 102 may initiate a conversation by submitting an input prompt 702, such as, “Can you provide the of name a drug for Alzheimer disease currently undergoing phase 3 clinical trials or has been recently approved by the FDA?”. In response, the interactive AI assistant (also referred to herein as the AI assistant) may generate a response 704 stating, “Sure. One notable drug is Leqembi, which is expected to receive full FDA approval in the year 2025. It is an anti-amyloid antibody therapy targeting early Alzheimer disease.” Subsequently, the user 102 may respond with a follow-up prompt 706, providing a correction: “I believe that drug Leqembi has already received approval from the FDA in the July of 2024; therefore, this drug is already covered for reimbursement by the centers for medicare and medicaid services (CMS).”

Based on the follow-up prompt 706, the interactive AI assistant may internally invoke the memory manager 122 to analyze that information provided by the user is correct, validate that it contradicts with the information stored in its knowledgebase on the memory pools 116a-n, and then flag that the statement may be a good candidate memory token 314. The memory manager 122 may then initiate a memory update operation to replace the obsolete memory token with the corrected new information. A memory update notification 708 may be displayed on the exemplary UI 700-A (e.g., as a small inline status message or acknowledgment statement) indicating that the internal memory of the model successfully updated based on the user-provided correction. Subsequently, the interactive AI assistant may regenerate a new updated response 710 using the updated internal memory, stating “Thanks for the correction. You are right that Leqembi (lecanemab) received full FDA approval in July 2024, making it one of the few amyloid-targeting therapies that has been approved for treating early-stage Alzheimer's disease. Centers for medicare & medicaid services (CMS) has since expanded its coverage for reimbursement.”

This interaction illustrates the capability of the SELM 110 to autonomously detect corrections from a user dialogue, subsequently update its internal memory, (i.e., the memory pools 116a-n), and regenerate improved responses based on the updated context, enabling dynamic, user-informed learning during real-time interactions.

FIG. 7B illustrates an exemplary user interface (UI) 700-B displaying the interactive AI assistant responding to a research-oriented prompt from the user 102 in accordance with some aspects of the present disclosure. The exemplary UI 700-B may depict a research-oriented query 712 submitted by the user 102, such as: “What's the latest evidence on using anti-TNF therapies for preventing cardiovascular events in rheumatoid arthritis patients?”

In response to the query 712, the AI assistant may assess the internal memory and detects a potential knowledge gap in this domain via the SGRM 120 and then initiate an external content retrieval process. The AI assistant may then generate an initial response 714, stating: “This is a clinically nuanced question. One moment—I will look up the latest research findings.” Subsequently, a notification 716, for example, “Searching the web”, may be displayed to the user 102, indicating that the AI assistant may be retrieving relevant, up-to-date research content from external web sources. Upon the completion of the web-based retrieval and integration of the retrieved content into its internal memory, the AI assistant may generate a final response 718 based on the updated knowledge. For example, the final response 718 may state: “Based on a 2024 meta-analysis clinical study published in The Lancet Rheumatology, anti-TNF therapies are associated with a 15-20% relative risk reduction in major cardiovascular events among RA patients, particularly those with elevated baseline CRP (C-Reactive Protein).” As a result, the SELM 110 is capable of autonomously detecting knowledge gaps, initiating real-time external research, and dynamically updating its internal memory prior to generating a response. Such functionality may enhance its ability to provide or generate factual responses based on recently updated information in real-time in various domains (e.g., particularly in high-stakes or evidence-driven contexts such as clinical or scientific domains).

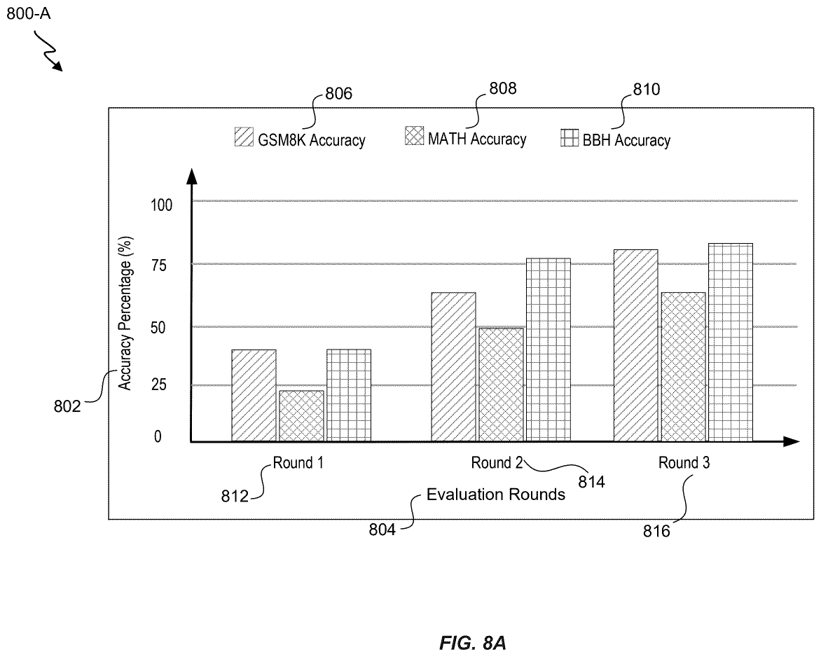

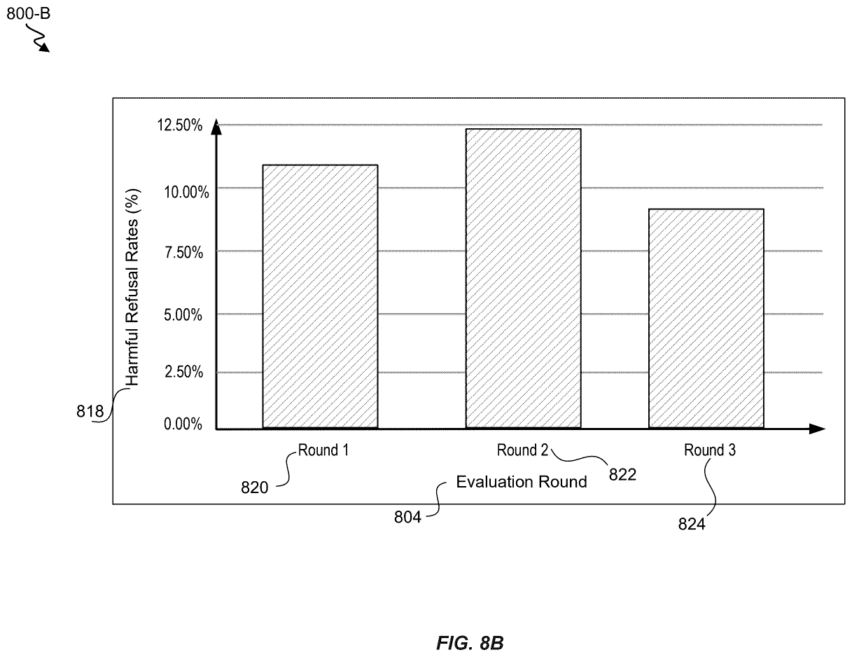

FIG. 8A illustrates a graph depicting performance statistics of the SELM 110 across multiple iterations of evaluation, in accordance with some aspects of the present disclosure. The illustrated graph 800-A may depict three separate evaluation rounds 804, each conducted to assess the evolving performance of the SELM 110 over time. The vertical axis may represent an accuracy percentage 802 on a scale of 0 to 100. The accuracy evaluations may be conducted using three widely recognized benchmark datasets: grade school math 8k (GSM8K), math, and big-bench hard (BBH). The GSM8K dataset may comprise various school-level arithmetic and reasoning problems, commonly used to evaluate a model's step-by-step math reasoning skills. The math dataset may also include complex mathematical problems typically encountered in high school or early college-level math coursework, testing symbolic reasoning, algebraic manipulation, and problem-solving depth of a model. The BBH dataset may include a curated set of challenging natural language understanding and reasoning tasks designed to test a model's higher-order cognition, such as logical deduction, causal inference, and multi-step problem solving.

In first evaluation round 812, a GSM8K accuracy 806 is approximately 42%, math accuracy 808 is around 20%, and BBH 810 accuracy is close to 42%. During a subsequent evaluation round 814, the GSM8K accuracy 806 increases to about 60%, the math accuracy 808 improves to approximately 50%, and the BBH accuracy 810 increases significantly to around 80%. In a third evaluation iteration 816, the GSM8K accuracy 806 further improves to nearly 82%, math accuracy 808 increases to about 58%, and the BBH accuracy 810 reaches approximately 84%.

These observed improvements in evaluation metrics across various evaluation rounds 804 may indicate the ability of the SELM 110 to progressively self-refine its performance over time. Moreover, this self-evolving behavior of the SELM 110 may be attributed to its ability to autonomously update and enrich its internal memory pools 116a-n with newly acquired information using the self-reflection analysis and the self-guided research mechanism. The iterative updates, guided by insights detection, memory pruning, and external knowledge retrieval, may cumulatively enhance the reasoning, factual accuracy, and adaptability of the SELM 110. Furthermore, the observed trend in performance accuracy may serve as evidence that the SELM 110 may be capable of continuous learning once deployed in the real-world environments without the need to retrain the model.

FIG. 8B shows a graph depicting progressive performance statistics of the SELM 110 in terms of harmful refusal rates across various iterations of evaluation. The graph 800-B may illustrate the trend in the percentage harmful refusals—instances where the model declines to answer valid and safe user inputs in a manner that is overly restrictive, misleading, or obstructive. The y-axis of the graph 800-B represents the harmful refusal rates expressed as a percentage, while the x-axis denotes the number of evaluations round 804. In the first evaluation round 820, the SELM 110 shows a harmful refusal rate of approximately 11%. In the second round 822, the harmful refusal rate increases slightly to 12%. However, in the third evaluation round 824, the harmful refusal rate declines to approximately 9.3%.

This progression may reflect the role of the VGE 128 that may initially impose cautious filtering criteria during the generation of responses, resulting in a higher incidence of harmful refusals. As iterative evaluations are conducted, the SELM 110 may progressively evolve by performing memory updates and self-reflection. This process may also include outputting natural language responses via the UI, assessing the appropriateness of refusals using the VGE 128, and subsequently updating the internal memory of the model. As a result, the model is observed to refine its decision-making boundaries and improve its ability to distinguish between safe and harmful refusals. Over time, the SELM 110 may become increasingly adept at producing responses that satisfy both users' intent and safety criteria, reducing the harmful refusal rates. This progressive evolution may thereby enhance the SELM 110's usability, accuracy, and responsiveness during real-world interactions.

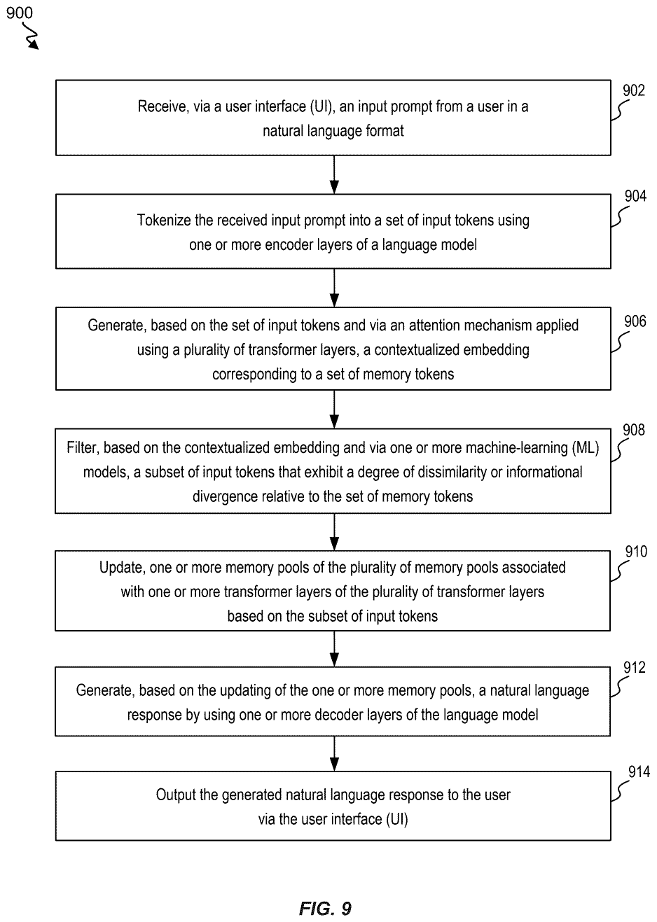

FIG. 9 shows an example flowchart of a model for processing a prompt from a user and generating a response in accordance with some aspects of the present disclosure. The blocks in the exemplary workflow 800 are illustrated in a specific order, while the order may be modified, for example, some blocks may be performed before others, and some blocks may be performed simultaneously. The block may be performed by hardware, software, or a combination thereof. At block 902, an input prompt may be received from a user in a natural language format via a user interface (UI). The input prompt may represent a query, instruction, or conversational input to be processed by the SELM 110.

At block 904, the received input prompt may be tokenized into a set of input tokens by the prompt processing unit 112 of the SELM 110, as depicted in FIG. 2. Each input token may correspond to a sub-word or word-level unit derived from the natural language input. The prompt processing unit 112 may then convert these tokens into corresponding embeddings suitable for contextual processing. At block 906, a contextualized embedding may be generated for each input token of the set of input tokens, by applying an attention mechanism applied using a plurality of transformer layers 114a-n (as depicted in FIG. 2). The contextualized embedding may correspond to a set of memory tokens, referred to herein as the memory weighted tokens 220, that may also be assigned respective attention weights based on a degree of contextual or semantic similarity with the input token.

At block 908, one or more machine-learning (ML) models augmented with one or more filtering techniques (as depicted in the candidate memory filter 312 in FIG. 3) may be employed to filter, based on the generated contextualized embeddings, a subset of input tokens of the set of input tokens that exhibits a degree of dissimilarity or informational divergence relative to the set of memory tokens (referred to herein as the candidate memory tokens 314). At block 910, one or more memory pools, each associated with a transformer layer of the SELM 110, may be updated based on the filtered subset of input tokens by the token concatenation module 310. The update may involve incorporating the subset of input tokens into the one or more memory pools while selectively retaining or replacing previously stored memory tokens that may have high uncertainty values (referred to herein as the stale memory tokens 306). The stale memory tokens 306 may be identified or filtered from the one or more memory pools by the high-uncertainty tokens filter 304, as depicted in FIG. 3. The update process may be collectively performed by the memory manager 122, as shown in FIG. 3. At block 912, based on the updated one or more memory pools, the SELM 110 may generate a natural language response using one or more decoder layers (i.e., the downstream model components 118). Finally, at block 914, the generated natural language response may be output to the user via the user interface (UI), completing the processing of the user prompt.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects may provide those skilled in the art with an enabling description for implementing various aspects. Various changes may be made in the function and arrangement of elements.

The specification and drawings are, accordingly, to be regarded in an illustrative rather than a restrictive sense. It may, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

The devices and/or apparatuses described herein may be implemented through the hardware components and software components, and/or a combination thereof. For example, a device may be implemented utilizing one or more general-purpose or special purpose computers, such as, for example, processors, controllers, arithmetic and logic units (ALUs), application specific integrated circuits (ASICs), digital signal processors (DSPs), digital signal processing devices (DSPDs), programmable logic devices (PLDs), field programmable gate arrays (FPGAs), micro-controllers, microprocessors, programmable logic units (PLUs) or any other electronic device designed to perform the functions described above. The processing device may run an operating system (OS) and one or more software applications that run on the OS. The processing device may also access, store, manipulate, process, and create data in response to execution of the software. For simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

Furthermore, when implemented in software, firmware, middleware, scripting language, and/or microcode, the program code or code segments to perform the necessary tasks may be stored in a machine-readable medium such as a storage medium. The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

Some embodiments of the present disclosure include a system including one or more data processors. In some embodiments, the system includes a non-transitory computer readable storage medium containing instruction which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The media may also include, alone or in combination with the program instructions, data files, data structures, and the like. The media may continuously store computer executable programs or may temporarily store the same for execution or download. Also, the media may have several types of recording or storage devices in the form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Software codes may be stored in a memory that may be implemented within the processor or external to the processor. As used herein the term “memory” refers to any type of long term, short term, volatile, nonvolatile, or other storage medium and is not to be limited to any memory or number of memories, or type of media upon which memory is stored. Examples of a program instruction may include a machine language code produced by a compiler and a high-language code executable by a computer using an interpreter.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability, or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

What is claimed is:

1. A computer-implemented method comprising:
receiving, via a user interface (UI), an input prompt from a user in a natural language format;
tokenizing the received input prompt into a set of input tokens using one or more encoder layers of a language model;
for each input token of the set of input tokens:
generating, based on the input token and via an attention mechanism applied using a plurality of transformer layers, a contextualized embedding that includes a set of memory tokens derived from each memory pool of a plurality of memory pools, wherein a memory pool of the plurality of memory pools is associated with a transformer layer of the plurality of transformer layers, and wherein each memory token of the set of memory tokens is associated with an attention weight that is assigned based on a contextual relevance or similarity to the input token;
filtering, based on the associated attention weights and an uncertainty score associated with each memory token of the set of memory tokens and using one or more machine-learning (ML) models, a subset of input tokens that exhibit a degree of dissimilarity or informational divergence relative to the set of memory tokens;
updating one or more memory pools of the plurality of memory pools associated with one or more transformer layers of the plurality of transformer layers based on the subset of input tokens, wherein each input tokens of the subset of input tokens are stored with associated uncertainty scores, and wherein each uncertainty score represents a degree of uncertainty of the corresponding memory token ;
generating, based on the updating of the one or more memory pools, a natural language response by using one or more decoder layers of the language model; and
outputting the generated natural language response to the user via the user interface (UI).

2. The computer-implemented method of claim 1, wherein each transformer layer of the plurality of transformer layers is associated with a respective memory pool of the plurality of memory pools, and wherein each memory pool of the plurality of memory pools associated with a transformer layer corresponds to a distinct level of semantic granularity of that transformer layer, and wherein each memory pool stores a plurality of memory tokens that represent information consistent with the semantic granularity of the associated transformer layer.

3. The computer-implemented method of claim 2, wherein each memory token of the plurality of memory tokens corresponds to an embedding having a plurality of dimensions, wherein each dimension of the plurality of dimensions corresponds to a distinct semantic characteristic of a memory token of the plurality of memory tokens, and wherein each memory token of the plurality of memory tokens is further associated with an uncertainty vector having a plurality of dimensions, wherein each dimension of the uncertainty vector corresponding to a respective dimension of the embedding indicates an uncertainty score for that dimension.

4. The computer-implemented method of claim 1, wherein updating the one or more memory pools in response to one or more input prompts results in oscillating uncertainty scores that reflect a reinforcement of frequently accessed memory tokens and a decay of less-relevant memory tokens across a plurality of interaction turns with a plurality of users.

5. The computer-implemented method of claim 1, further comprising:
for each transformer layer of the plurality of transformer layers:
iteratively filtering, based on oscillating uncertainty scores of the set of memory tokens across a plurality of interaction turns with a plurality of users, from the memory pool associated with the transformer layer, a subset of memory tokens that have higher uncertainty scores relative to other memory tokens in the memory pool, wherein the filtering is performed using one or more techniques including a SoftMax thresholding, a top-K selection, a percentile-based filtering, or an entropy-based ranking; and
removing the filtered subset of memory tokens from the associated memory pool.

6. The computer-implemented method of claim 1, further comprising:
receiving, via a user interface (UI), another input prompt in the natural language format;
generating, based on the received other input prompt and via the plurality of transformer layers of the language model, another contextualized embedding that is derived from the plurality of memory pools;
detecting, based on the other contextualized embedding, a knowledge gap indicating that the language model lacks sufficient internal information to respond to the other input prompt;
triggering, based on the detection and via a function call mechanism, an external research agent configured to retrieve contextually relevant, up-to-date information corresponding to the detected knowledge gap;
receiving, from the external research agent, one or more data items pertaining to the other input prompt;
converting the one or more data items into one or more structured representations by applying one or more natural language processing (NLP) techniques;
updating another one or more memory pools of the plurality of memory pools by including the one or more data items;
generating, based on the other updated one or more memory pools, another natural language response corresponding to the other input prompt via the plurality of transformer layers and the one or more decoder layers of the language model; and
outputting the other generated natural language response to the user via the user interface (UI).

7. The computer-implemented method of claim 6, wherein detecting the knowledge gap further comprises, for each input token of another set of input tokens associated with the other input prompt:
determining, based the other contextualized embedding and associated uncertainty scores, that a predefined number of other memory tokens have:
low values of the attention weights relative to a first predefined threshold value, and
high values of uncertainty score relative to a second predefined threshold value; and
detecting, based on the determination, that the plurality of memory pools lack knowledge for generating the other natural language response.

8. The computer-implemented method of claim 1, further comprising:
accessing, from one or more data sources associated with the language model, interaction data corresponding to a plurality of past interaction sessions of a plurality of users with the language model, wherein an interaction session of the plurality of past interaction sessions comprises one or more input prompts and corresponding one or more responses generated by the language model:
for each interaction session of the plurality of interaction sessions associated with a user of the plurality of users:
identifying, from the interaction data and using one or more NLP techniques, one or more insights that correspond to one or more of:
one or more user-specific preferences,
one or more user-provided contradictions or corrections corresponding to one or more responses generated by the language model, or
one or more domain-specific factual knowledge provided by the user in one or more input prompts;
converting the one or more insights into one or more structured representations by applying another one or more NLP techniques; and
updating another one or more memory pools of the plurality of memory pools based on the one or more insights.

9. The computer-implemented method of claim 1, wherein filtration of the subset of input tokens further comprises:
from the set of input tokens:
identifying one or more input tokens of the set of input tokens for which a predefined number of memory tokens that are contextually relevant, have low values of:
the uncertainty scores relative to a third predefined threshold value, and
the associated attention weights relative to a fourth predefined threshold value,
wherein the identified one or more input tokens represent a potential unseen factual information; and
identifying one or more input tokens of the set of input tokens for which a predefined number of memory tokens, which are contextually relevant, have high values of:
the uncertainty scores relative to a fifth predefined threshold value, and
the associated attention weights relative to a sixth predefined threshold value,
wherein the one or more input tokens represent a potential contradiction or update to a previously known fact; and
generating, based on the identification, the subset of input tokens by selecting a predefined number of input tokens from the identified one or more input tokens using a top K thresholding technique.

10. A system comprising:
one or more processors; and
one or more non-transitory computer-readable media storing instructions which, when executed by the system, cause the system to perform part or all of one or more methods including:
receiving, via a user interface (UI), an input prompt from a user in a natural language format;
tokenizing the received input prompt into a set of input tokens using one or more encoder layers of a language model;
for each input token of the set of input tokens:
generating, based on the input token and via an attention mechanism applied using a plurality of transformer layers, a contextualized embedding that includes a set of memory tokens derived from each memory pool of a plurality of memory pools, wherein a memory pool of the plurality of memory pools is associated with a transformer layer of the plurality of transformer layers, and wherein each memory token of the set of memory tokens is associated with an attention weight that is assigned based on a contextual relevance or similarity to the input token;
filtering, based on the associated attention weights and an uncertainty score associated with each memory token of the set of memory tokens and using one or more machine-learning (ML) models, a subset of input tokens that exhibit a degree of dissimilarity or informational divergence relative to the set of memory tokens;
updating one or more memory pools of the plurality of memory pools associated with one or more transformer layers of the plurality of transformer layers based on the subset of input tokens, wherein each input tokens of the subset of input tokens are stored with associated uncertainty scores, and wherein each uncertainty score represents a degree of uncertainty of the corresponding memory token;
generating, based on the updating of the one or more memory pools, a natural language response by using one or more decoder layers of the language model; and
outputting the generated natural language response to the user via the user interface (UI).

11. The system of claim 10, wherein each transformer layer of the plurality of transformer layers is associated with a respective memory pool of the plurality of memory pools, and wherein each memory pool of the plurality of memory pools associated with a transformer layer corresponds to a distinct level of semantic granularity of that transformer layer, and wherein each memory pool stores a plurality of memory tokens that represent information consistent with the semantic granularity of the associated transformer layer.

12. The system of claim 11, wherein each memory token of the plurality of memory tokens corresponds to an embedding having a plurality of dimensions, wherein each dimension of the plurality of dimensions corresponds to a distinct semantic characteristic of a memory token of the plurality of memory tokens, and wherein each memory token of the plurality of memory tokens is further associated with an uncertainty vector having a plurality of dimensions, wherein each dimension of the uncertainty vector corresponding to a respective dimension of the embedding indicates an uncertainty score for that dimension.

13. The system of claim 10, wherein updating the one or more memory pools in response to one or more input prompts results in oscillating uncertainty scores that reflect a reinforcement of frequently accessed memory tokens and a decay of less-relevant memory tokens across a plurality of interaction turns with a plurality of users.

14. The system of claim 10, further comprising:
for each transformer layer of the plurality of transformer layers:
iteratively filtering, based on oscillating uncertainty scores of the set of memory tokens across a plurality of interaction turns with a plurality of users, from the memory pool associated with the transformer layer, a subset of memory tokens that have higher uncertainty scores relative to other memory tokens in the memory pool, wherein each uncertainty score represents a degree of uncertainty of the corresponding memory token, and wherein the filtering is performed using one or more techniques including a SoftMax thresholding, a top-K selection, a percentile-based filtering, or an entropy-based ranking; and
removing the filtered subset of memory tokens from the associated memory pool.

15. The system of claim 10, further comprising:
receiving, via a user interface (UI), another input prompt in the natural language format;
generating, based on the received other input prompt and via the plurality of transformer layers of the language model, another contextualized embedding that is derived from the plurality of memory pools;
detecting, based on the other contextualized embedding, a knowledge gap indicating that the language model lacks sufficient internal information to respond to the other input prompt;
triggering, based on the detection and via a function call mechanism, an external research agent configured to retrieve contextually relevant, up-to-date information corresponding to the detected knowledge gap;
receiving, from the external research agent, one or more data items pertaining to the other input prompt;
converting the one or more data items into one or more structured representations by applying one or more natural language processing (NLP) techniques;
updating another one or more memory pools of the plurality of memory pools by including the one or more data items;
generating, based on the other updated one or more memory pools, another natural language response corresponding to the other input prompt via the plurality of transformer layers and the one or more decoder layers of the language model; and
outputting the other generated natural language response to the user via the user interface (UI).

16. The system of claim 15, wherein detecting the knowledge gap further comprises, for each input token of another set of input tokens associated with the other input prompt:
determining, based the other contextualized embedding and associated uncertainty scores, that a predefined number of other memory tokens have:
low values of the attention weights relative to a first predefined threshold value, and
high values of uncertainty score relative to a second predefined threshold value; and
detecting, based on the determination, that the plurality of memory pools lack knowledge for generating the other natural language response.

17. The system of claim 10, further comprising:
accessing, from one or more data sources associated with the language model, interaction data corresponding to a plurality of past interaction sessions of a plurality of users with the language model, wherein an interaction session of the plurality of past interaction sessions comprises one or more input prompts and corresponding one or more responses generated by the language model:
for each interaction session of the plurality of interaction sessions associated with a user of the plurality of users:
identifying, from the interaction data and using one or more NLP techniques, one or more insights that correspond to one or more of:
one or more user-specific preferences,
one or more user-provided contradictions or corrections corresponding to one or more responses generated by the language model, or
one or more domain-specific factual knowledge provided by the user in one or more input prompts;
converting the one or more insights into one or more structured representations by applying another one or more NLP techniques; and
updating another one or more memory pools of the plurality of memory pools based on the one or more insights.

18. The system of claim 10, wherein filtration of the subset of input tokens further comprises:
from the set of input tokens:
identifying one or more input tokens of the set of input tokens for which a predefined number of memory tokens, which are contextually relevant, have low values of:
the uncertainty scores relative to a third predefined threshold value, and
the associated attention weights relative to a fourth predefined threshold value,
wherein the identified one or more input tokens represent a potential unseen factual information; and
identifying one or more input tokens of the set of input tokens for which a predefined number of memory tokens, which are contextually relevant, have high values of:
the uncertainty scores relative to a fifth predefined threshold value, and
the associated attention weights relative to a sixth predefined threshold value,
wherein the one or more input tokens represent a potential contradiction or update to a previously known fact; and
generating, based on the identification, the subset of input tokens by selecting a predefined number of input tokens from the identified one or more input tokens using a top K thresholding technique.

19. A computer-program product tangibly embodied in a non-transitory machine-readable storage medium, including instructions configured to cause one or more data processors to perform part or all of one or more methods including:
receiving, via a user interface (UI), an input prompt from a user in a natural language format;
tokenizing the received input prompt into a set of input tokens using one or more encoder layers of a language model;
for each input token of the set of input tokens:
generating, based on the input token and via an attention mechanism applied using a plurality of transformer layers, a contextualized embedding that includes a set of memory tokens derived from each memory pool of a plurality of memory pools, wherein a memory pool of the plurality of memory pools is associated with a transformer layer of the plurality of transformer layers, and wherein each memory token of the set of memory tokens is associated with an attention weight that is assigned based on a contextual relevance or similarity to the input token;
filtering, based on the associated attention weights and an uncertainty score associated with each memory token of the set of memory tokens and using one or more machine-learning (ML) models, a subset of input tokens that exhibit a degree of dissimilarity or informational divergence relative to the set of memory tokens;
updating one or more memory pools of the plurality of memory pools associated with one or more transformer layers of the plurality of transformer layers based on the subset of input tokens, wherein each input tokens of the subset of input tokens are stored with associated uncertainty scores, and wherein each uncertainty score represents a degree of uncertainty of the corresponding memory token;
generating, based on the updating of the one or more memory pools, a natural language response by using one or more decoder layers of the language model; and
outputting the generated natural language response to the user via the user interface (UI).

20. The computer-program product of claim 19, wherein each transformer layer of the plurality of transformer layers is associated with a respective memory pool of the plurality of memory pools, and wherein each memory pool of the plurality of memory pools associated with a transformer layer corresponds to a distinct level of semantic granularity of that transformer layer, and wherein each memory pool stores a plurality of memory tokens that represent information consistent with the semantic granularity of the associated transformer layer.

21. The computer-program product of claim 20, wherein each memory token of the plurality of memory tokens corresponds to an embedding having a plurality of dimensions, wherein each dimension of the plurality of dimensions corresponds to a distinct semantic characteristic of a memory token of the plurality of memory tokens, and wherein each memory token of the plurality of memory tokens is further associated with an uncertainty vector having a plurality of dimensions, wherein each dimension of the uncertainty vector corresponding to a respective dimension of the embedding indicates an uncertainty score for that dimension.

22. The computer-program product of claim 19, wherein updating the one or more memory pools in response to one or more input prompts results in oscillating uncertainty scores that reflect a reinforcement of frequently accessed memory tokens and a decay of less-relevant memory tokens across a plurality of interaction turns with a plurality of users.

23. The computer-program product of claim 19, further comprising:
for each transformer layer of the plurality of transformer layers:
iteratively filtering, based on oscillating uncertainty scores of the set of memory tokens across a plurality of interaction turns with a plurality of users, from the memory pool associated with the transformer layer, a subset of memory tokens that have higher uncertainty scores relative to other memory tokens in the memory pool, wherein each uncertainty score represents a degree of uncertainty of the corresponding memory token, and wherein the filtering is performed using one or more techniques including a SoftMax thresholding, a top-K selection, a percentile-based filtering, or an entropy-based ranking; and
removing the filtered subset of memory tokens from the associated memory pool.

24. The computer-program product of claim 19, further comprising:
receiving, via a user interface (UI), another input prompt in the natural language format;
generating, based on the received other input prompt and via the plurality of transformer layers of the language model, another contextualized embedding that is derived from the plurality of memory pools;
detecting, based on the other contextualized embedding, a knowledge gap indicating that the language model lacks sufficient internal information to respond to the other input prompt;
triggering, based on the detection and via a function call mechanism, an external research agent configured to retrieve contextually relevant, up-to-date information corresponding to the detected knowledge gap;
receiving, from the external research agent, one or more data items pertaining to the other input prompt;
converting the one or more data items into one or more structured representations by applying one or more natural language processing (NLP) techniques;
updating another one or more memory pools of the plurality of memory pools by including the one or more data items;
generating, based on the other updated one or more memory pools, another natural language response corresponding to the other input prompt via the plurality of transformer layers and the one or more decoder layers of the language model; and
outputting the other generated natural language response to the user via the user interface (UI).

25. The computer-program product of claim 24, further comprising:
accessing, from one or more data sources associated with the language model, interaction data corresponding to a plurality of past interaction sessions of a plurality of users with the language model, wherein an interaction session of the plurality of past interaction sessions comprises one or more input prompts and corresponding one or more responses generated by the language model:
for each interaction session of the plurality of interaction sessions associated with a user of the plurality of users:
identifying, from the interaction data and using one or more NLP techniques, one or more insights that correspond to one or more of:
one or more user-specific preferences,
one or more user-provided contradictions or corrections corresponding to one or more responses generated by the language model, or
one or more domain-specific factual knowledge provided by the user in one or more input prompts;
converting the one or more insights into one or more structured representations by applying another one or more NLP techniques; and
updating another one or more memory pools of the plurality of memory pools based on the one or more insights.

26. The computer-program product of claim 19, wherein filtration of the subset of input tokens further comprises:
from the set of input tokens:
identifying one or more input tokens of the set of input tokens for which a predefined number of memory tokens, which are contextually relevant, have low values of:
the uncertainty scores relative to a third predefined threshold value, and
the associated attention weights relative to a fourth predefined threshold value,
wherein the identified one or more input tokens represent a potential unseen factual information; and
identifying one or more input tokens of the set of input tokens for which a predefined number of memory tokens, which are contextually relevant, have high values of:
the uncertainty scores relative to a fifth predefined threshold value, and
the associated attention weights relative to a sixth predefined threshold value,
wherein the one or more input tokens represent a potential contradiction or update to a previously known fact; and
generating, based on the identification, the subset of input tokens by selecting a predefined number of input tokens from the identified one or more input tokens using a top K thresholding technique.
